(19) United States
(12) Patent Application Publication
(10) Pub. No.: US 2017/0188600 A1
(43) Pub. Date: Jul. 6, 2017

(54) VESSEL, SYSTEM, AND METHOD FOR PREPARING A FROZEN FOOD

(71) Applicant: Looksee, Inc, New York, NY (US)

(72) Inventors: Laura Rose Semo Scharfman, San Francisco, CA (US); Todd Bakken, Madison, WI (US); Walter Blaurock, Brooklyn, NY (US); Thomas Nguyen, Brooklyn, NY (US); Bart Stein, New York, NY (US); Michael Van Dyke, Madison, WI (US); Albert Ho, New York, NY (US); Evan Abel, Brooklyn, NY (US)

(21) Appl. No.: 15/357,860

(22) Filed: Nov. 21, 2016

Related U.S. Application Data
(60) Provisional application No. 62/362,220, filed on Jul. 14, 2016.
(60) Provisional application No. 62/258,227, filed on Nov. 20, 2015.

(51) Int. Cl. A23G 9/10; A23G 9/22

(52) U.S. Cl. CPC A23G 9/10; A23G 9/228

(57) ABSTRACT

One variation of a method for preparing a frozen food product includes: following insertion of a vessel into a receiver: activating a cooling element thermally coupled to the receiver; transitioning a rotary motor from rest to a first target angular speed; and setting a first timer of a first duration; in response to expiration of the first timer and detection of contents of the vessel approximating a first target viscosity: reducing an angular speed of the rotary motor; and setting a second timer of a second duration; in response to expiration of the second timer and detection of the contents of the vessel approximating a second target viscosity: reducing the angular speed of the rotary motor; and setting a third timer of a third duration; in response to expiration of the third timer: reducing the angular speed of the rotary motor; and indicating completion of a frozen food product.

### CROSS-REFERENCE TO RELATED APPLICATIONS

This Application claims the benefit of U.S. Provisional Application No. 62/258,227, filed on 20 Nov. 2015, which is incorporated in its entirety by this reference.

This Application claims the benefit of U.S. Provisional Application No. 62/362,220, filed on 14 Jul. 2016, which is incorporated in its entirety by this reference.

### TECHNICAL FIELD

This invention relates generally to the field of frozen desserts and more specifically to a new and useful vessel, system, and method for preparing a frozen food in the field of frozen desserts.

### BRIEF DESCRIPTION OF THE FIGURES

FIG. 1 is a schematic representation of a vessel;

FIGS. 2A and 2B are schematic representations of an apparatus;

FIG. 3 is a flowchart representation of a method;

FIG. 4 is a graphical representation of one variation of the method;

FIGS. 5A, 5B, and 5C are schematic representations of one variation of the vessel;

FIG. 6 is a schematic representation of one variation of the apparatus;

FIG. 7 is a flowchart representation of one variation of the apparatus;

FIG. 8 is a schematic representation of one variation of the vessel;

FIGS. 9A, 9B, and 9C are schematic representations of one variation of the vessel;

FIG. 10 is a flowchart representation of one variation of the method; and

FIGS. 11A and 11B are schematic representations of one variation of the apparatus.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Vessel, Apparatus, and Method

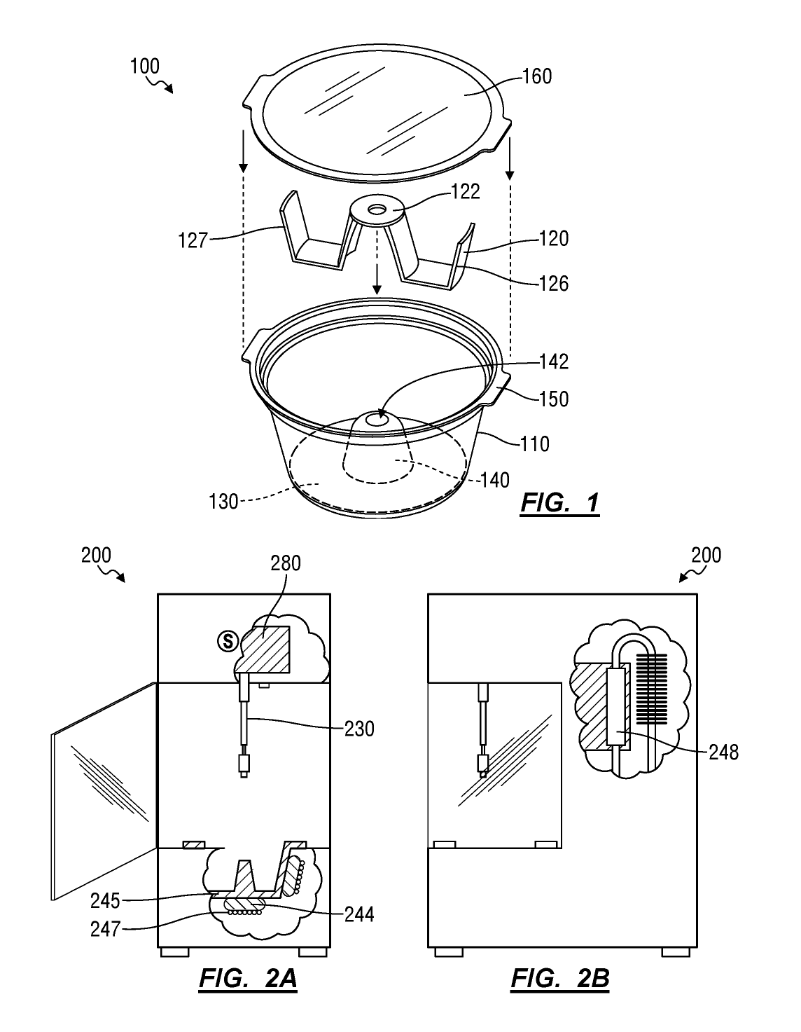

As shown in FIG. 1, a vessel 100 for storing and preparing a frozen food includes: an outer wall 110 comprising a first (frustoconical) section defining a central axis and declined toward the central axis; a rim 150 extending laterally from an upper edge of the outer wall 110 and away from the central axis; and a base 130 extending from a lower edge of the outer wall 110 toward the central axis. The vessel 100 further includes a beater 120, which includes: a drive coupling 122 arranged over the shelf and configured to rotate about the central axis; a first blade 126 extending from the drive coupling 122, along the base 130, and up a portion of the outer wall 110; and a second blade 127 radially offset from the first blade 126 and extending from the drive coupling 122, along the base 130, and up a portion of the outer wall 110. The vessel 100 also includes: a seal 160 extending across the upper edge of the outer wall 110 and transiently enclosing a volume defined by the outer wall 110 and the base 130; and a powdered food product contained within the volume.

As shown in FIGS. 2A and 2B, an apparatus 200 for freezing a liquid food product includes: a base 202 202; a receiver 220 arranged in the base 202 and configured to transiently receive the vessel 100, the receiver 220 comprising a thermally-conductive material and defining an internal frustoconical section of a draft angle approximating a draft angle of the frustoconical vessel 100; a cooling element (or “refrigeration unit 240”) arranged in the base 202 and thermally coupled to the receiver 220; a lid 260 arranged over the receiver 220, pivotably coupled to the base 202, and operable in an open position and a closed position; a rotary motor 280 arranged within the lid 260; a driveshaft 230 coupled to the rotary motor 280 and configured to transiently engage a beater arranged in the vessel 100 and to depress the vessel 100 into the receiver 220 when the lid 260 is in the closed position; and a window 270 extending from the lid and configured to enclose the vessel 100 and the driveshaft 230 between the base 202 and the lid 260 when the lid 260 is in the closed position.

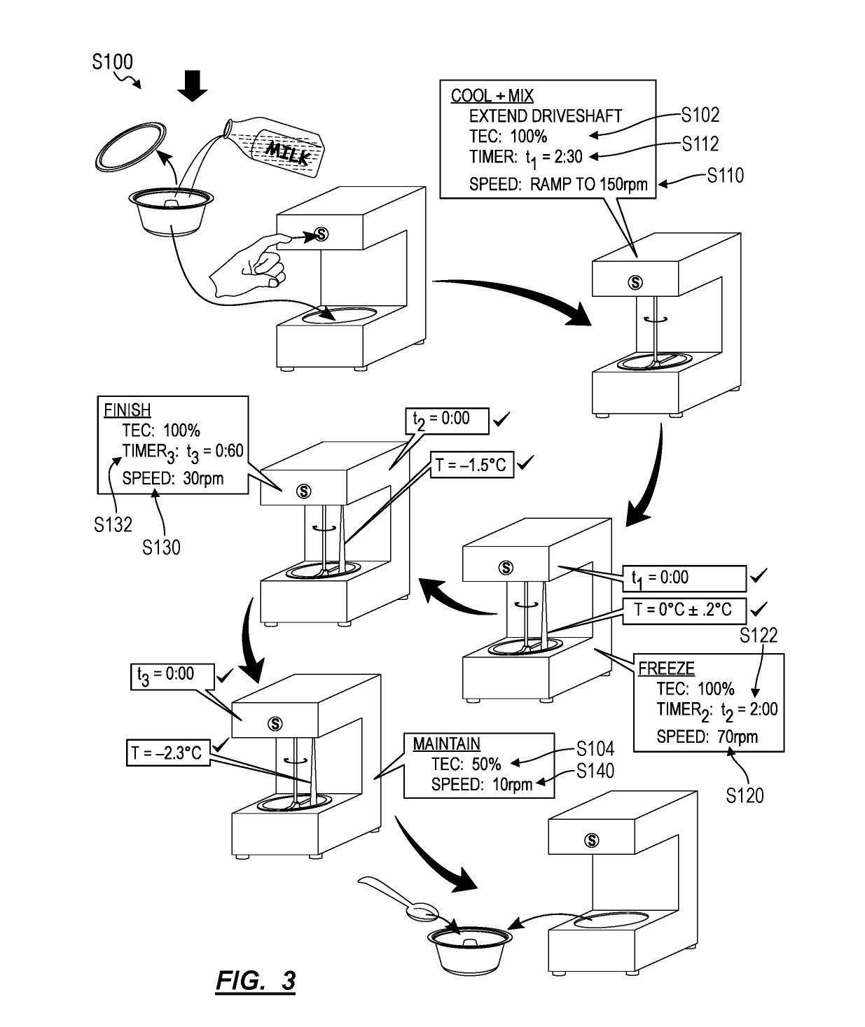

As shown in FIG. 3, a method S100 for preparing a frozen food product includes, following insertion of a vessel 100 containing a liquid food product into a receiver: activating a cooling element thermally coupled to the receiver at a first power level in Block S102; transitioning a rotary motor from rest to a first target angular speed in Block S110, the rotary motor mechanically coupled to a beater integrated into the vessel 100; and setting a first timer of a first duration in Block S112. The method S100 also includes, in response to expiration of the first timer and detection of contents of the vessel 100 approximating a first target viscosity: reducing an angular speed of the rotary motor from the first target angular speed to a second target angular speed in Block S120; and setting a second timer of a second duration in Block S122. Furthermore, the method S100 includes, in response to expiration of the second timer and detection of the contents of the vessel 100 approximating a second target viscosity greater than the first target viscosity: reducing the angular speed of the rotary motor from the second target angular speed to a third target angular speed in Block S130; and setting a third timer of a third duration in Block S132. Finally, the method S100 includes, in response to expiration of the third timer: reducing the angular speed of the rotary motor from the third target angular speed to a fourth target angular speed in Block S140; and indicating completion of a frozen food product in the vessel 100 in Block S150.

One variation of the method S100 includes, following insertion of a vessel 100 containing the liquid food product into a receiver: activating a cooling element thermally coupled to the receiver at a first power level in Block S102; transitioning a rotary motor from rest to a first target angular speed in Block S110, the rotary motor mechanically coupled to a beater integrated into the vessel 100; and setting a first timer of a first duration in Block S112. The method also includes, at the earlier of expiration of the first timer and detection of contents of the vessel 100 approximating a first target viscosity, transitioning the rotary motor from the first target angular speed to a second target angular speed in Block S120. Furthermore, the method includes, at the earlier of expiration of the second timer and detection of contents of the vessel 100 approximating a second target viscosity greater than the first target viscosity: transitioning the rotary motor from the second target angular speed to a third target angular speed in Block S130.

### 2. Applications

Generally, the vessel 100 functions as: a storage container for a dry food product (e.g., a frozen yogurt base); a preparation container in which the dry food product is transformed into a wet, frozen, edible suspension (e.g., frozen yogurt) following addition of a liquid (e.g., fresh whole milk); and a bowl from which the suspension may be consumed by a user. In particular, the vessel 100: defines a thermally-conductive container that conducts heat from its contents into an adjacent heatsink (i.e., the receiver in the apparatus 200); and includes an integrated beater that, when rotated within the vessel 100, mixes the dry food product with liquid added to the vessel 100 and scrapes ice crystals from the wall of the vessel 100. The vessel 100 further defines a frustoconical form defined by tapered walls declining toward the base of the vessel 100 that pairs with the tapered form of the receiver 200 to establish flush and consistent thermal contact between the vessel 100 and the receiver. The beater integrated into the vessel 100 defines a male (or female) drive coupling capable of mating (“interlocking”) with the driveshaft of the apparatus 200. Because all surfaces that contact the yogurt base and liquid during processing are contained and integrated in the vessel 100 (i.e., wall of the vessel 100, the beater), little or no cleaning of the apparatus 200 may be needed between uses, while the vessel 100 and all of the contents included therein may be disposed after use (e.g., the vessel 100 can be disposed of after being used once). Furthermore, because only addition of a liquid (e.g., whole milk) to the vessel 100 is required for a user to prepare the frozen yogurt base for conversion into frozen yogurt and because this liquid may be relatively “fresh” (e.g., grocery store-supplied 2% milk used prior to an expiration date, farm-fresh whole milk, etc.), the vessel 100 can be processed in the apparatus 200 to create fresh frozen yogurt in a convenient period of time (e.g., less than ten minutes) and with relatively minimal preparation or effort by the user.

Generally, the apparatus 200 can define a home (e.g., countertop) frozen yogurt preparation machine that receives a vessel 100 with frozen yogurt base and a fresh liquid and then mixes, beats, and cools the vessel 100 to prepare one or more servings of frozen yogurt within the vessel 100. In particular, the apparatus 200 can include: a receiver that receives a vessel 100; a refrigeration unit that cools the receiver, thereby cooling the vessel 100 and its contents; a drive unit that couples to and rotates the beater; a non-contact (e.g., infrared) temperature sensor; and a controller. The drive unit includes a driveshaft coupled to a rotary motor and defining a female (or male) drive coupling capable of mating with the male drive coupling of the beater integrated into the vessel 100 and rotating the beater by translating torque supplied to the driveshaft by a rotary motor. The drive unit also cooperates with the lid to apply a downward force on the vessel 100 to depress the vessel 100 into the receiver, thereby improving thermal contact between the vessel 100 and the receiver. The thermal contact between the vessel 100 and the receiver enables the receiver to effectively cool the vessel 100 and the contents in the vessel 100 while the driveshaft mates with and rotates the beater to prepare fresh frozen yogurt in the vessel 100.

Generally, the method S100 can be implemented by the controller integrated into the apparatus 200 to vary the power of the refrigeration unit and the speed of the drive unit based on outputs of the temperature sensor to achieve a target viscosity and mouth feel of frozen contents of the vessel 100. In particular, the apparatus 200 adjusts a power level of the refrigeration unit and a speed of the beater in real-time throughout a vessel 100 processing cycle based on the temperature of the contents of the vessel 100 in order to achieve a target viscosity and mouth feel of a final food product in the vessel 100 regardless of a starting temperature of the receiver, a starting temperature of contents of the vessel 100, or a type of liquid added to the vessel 100 by a user before the processing cycle, such as whole milk pulled directly from a very cold (e.g., 2° C.) refrigerator or room-temperature (e.g., 23° C.) almond milk. The apparatus can also process the contents of the vessel 100 in a series of preparation stages, wherein each preparation stage defines a particular combination of power level of the refrigeration unit, angular speed of the rotary motor, and triggers for transitioning to the next preparation stage to achieve a particular effect on the contents of the vessel 100. For example, the apparatus can prepare a frozen yogurt by processing the contents in the vessel 100 in three preparation stages: a cool and mix stage; a freeze stage following the cool and mix stage; and a finish stage following the freeze stage. The apparatus can transition between preparation stages based on a determination of the viscosity of the contents in the vessel 100, such as based on a power supplied to the motor to maintain a target angular speed or based on a measured temperature of contents of the vessel. The apparatus 200 can also implement minimum time thresholds for select preparation stages during a processing cycle, as in Blocks S120 and S130, in order to achieve at least a minimum proportion of frozen content in the vessel 100 upon completion of the processing cycle regardless of inconsistencies in outputs of the temperature sensor over time.

### 3. Example Implementations

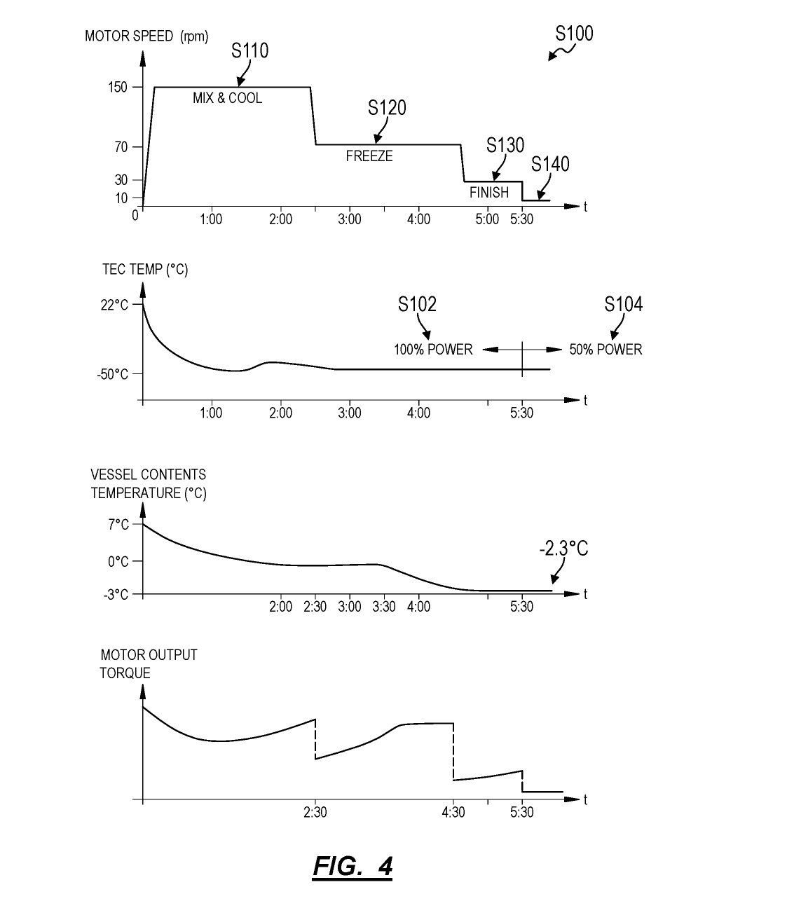

In one example, the vessel 100 defines a drawn or spun aluminum container, includes a nylon beater, and includes a foil-backed lid that seals a freeze-dried mixture of sugar, yogurt cultures, and fruit in a powdered format (e.g., particles with maximum dimensions less than 0.075″) within the vessel 100. In this example, to prepare the contents of the vessel 100 for consumption, a user peels the lid from the vessel 100, adds a liquid (e.g., whole milk, 2% milk, soy milk, water, fruit juice, etc.) to the vessel 100 up to a fill line defined by the top of the stanchion, inserts the vessel 100 into the receiver in the apparatus 200, and selects a single “Start” button on the apparatus 200. In response to selection of the “Start” button, the apparatus 200 activates the refrigeration unit at full-power (e.g., 100% duty) in Block S102, automatically extends the driveshaft down toward the vessel 100 until the end of the driveshaft engages the drive coupler of the beater, and ramps the rotary motor—coupled to the driveshaft—from stationary to a first target speed of 150 rpm (e.g., +/−5%) over a period of ten seconds in Block S110, as shown in FIG. 4. When the rotary motor reaches the first target speed, the apparatus 200 sets a first timer for 140 seconds in Block S112. While the first timer counts down, the rotary motor and the beater cooperate to mix the contents of the vessel 100 and to expose these contents to the cooled interior wall of the vessel 100.

In this example, at the later of expiration of the first timer and a temperature reading from the temperature sensor that indicates contents of the vessel 100 have dropped below a first target temperature of 0° C., the apparatus 200 slows the rotary motor to a second target speed of ˜70 rpm in Block S120 and sets a second timer for a duration of 120 seconds in Block S122. While the second timer counts down, the reduced speed of the rotary motor allows ice crystals to form on the interior wall of the vessel 100, and the beater scrapes these ice crystals from the interior wall of the vessel 100 and mixes these ice crystals into the bulk contents of the vessel 100. At the later of expiration of the second timer and a temperature reading from the temperature sensor that indicates the contents of the vessel 100 have dropped below a second target temperature of −1° C., the apparatus 200 slows the rotary motor to a third target speed of ˜30 rpm in Block S130 and sets a third timer for a duration of 60 seconds in Block S132. While the third timer counts down, the apparatus 200 can rotate the beater at this further reduced speed to aerate contents of the vessel 100, to allow longer (e.g., larger) ice crystals to form within the vessel 100, and to finish the frozen food product in the vessel 100 (e.g., achieve a target mouth feel and texture). Once the third timer expires, the apparatus 200 can indicate that the frozen food product is ready for consumption, such as by flashing a light or sounding an audible alert in Block S150. Between completion of the frozen food product and removal of the vessel 100 from the receiver, the apparatus 200 can slow the rotary motor to a final target speed of ˜10 rpm in Block S140 and reduce the power output of the refrigeration unit (e.g., to a 50% duty) in Block S104 in order to maintain the state of the contents of the vessel 100, such as if the user is not immediately available to retrieve the vessel 100 and consume its contents, as shown in FIG. 4.

In another example, the vessel 100 defines a drawn or spun aluminum container, includes a nylon beater, and includes an aluminum foil backed lid that seals a freeze-dried mixture of sugar, yogurt cultures, and fruit in a powdered format (e.g., particles with maximum dimensions less than 0.075″) within the vessel 100. In this example, to prepare the contents of the vessel 100 for consumption, a user peels the lid from the vessel 100, adds a liquid (e.g., whole milk, water, fruit juice, etc.) to the vessel 100 up to a fill line printed on the interior wall of the vessel 100, inserts the vessel 100 into the receiver in the apparatus 200, pivots the drive unit from an open position to a closed position, and selects a single “Start” button on the apparatus 200. In response to selection of the “Start” button, the apparatus 200 activates the refrigeration unit at full-power (e.g., 100% duty) in Block S102 and ramps the rotary motor—coupled to the driveshaft in the drive unit—from a rest state to a first target speed of 150 rpm (e.g., +/−5%) over a period of ten seconds in Block S110. When the rotary motor reaches the first target speed, the apparatus 200 sets a first timer for 140 seconds in Block S112. While the first timer counts down, the rotary motor and the beater cooperate to mix the contents of the vessel 100 and expose these contents to the cooled interior wall of the vessel 100.

In this example, at the later of expiration of the first timer and a sensing of a back EMF draw (i.e., the voltage drawn by the rotary motor to maintain the first target speed) that indicates that the contents of the vessel 100 have reached a first target viscosity (e.g., 100 centipoise (cP)), the apparatus 200 slows the rotary motor to a second target speed of ˜70 rpm in Block S120 and sets a second timer for a duration of 120 seconds in Block S122. While the second timer counts down, the reduced speed of the rotary motor allows ice crystals to form on the interior wall of the vessel 100, and the beater scrapes these ice crystals from the interior wall of the vessel 100 and mixes these ice crystals into the bulk contents of the vessel 100. At the later of expiration of the second timer and a back EMF draw that indicates that the contents of the vessel 100 have reached a second target viscosity (e.g., 1000 cP), the apparatus 200 slows the rotary motor to a third target speed of ˜30 rpm in Block S130 and sets a third timer for a duration of 60 seconds in Block S132. While the third timer counts down, the apparatus 200 can rotate the beater at this reduced speed to aerate the contents of the vessel 100, to allow larger ice crystals to form within the vessel 100, and to finish the frozen food product in the vessel 100 (e.g., achieve a target mouth feel and texture). Once the third timer expires, the apparatus 200 can indicate that the frozen food product is ready for consumption, such as by flashing a light or sounding an audible alert in Block S150. Between completion of the frozen food product and removal of the vessel 100 from the receiver, the apparatus 200 can slow the rotary motor to a final target speed of ˜10 rpm in Block S140 and reduce the power output of the refrigeration unit (e.g., to a 50% duty) in Block S104 in order to maintain the state of the contents of the vessel 100, such as if the user is not immediately available to retrieve the vessel 100 and consume its contents, as shown in FIG. 4.

As in the foregoing examples, the vessel 100 is described as containing a base food product for frozen yogurt (or a frozen yogurt-like product) that is processed in situ with a fresh milk product to create a frozen yogurt (or a frozen yogurt-like product) that may be consumed directly from the vessel 100. Similarly, the apparatus 200 is described herein as executing a method for cooling and beating a frozen yogurt base—mixed with a fresh milk product—to create frozen yogurt (or a frozen yogurt-like product) within such a vessel 100. However, the vessel 100 can alternatively contain a base food product for ice cream, gelato, or any other frozen food product, and the apparatus 200 can similarly implement a method for cooling and beating such a base to create ice cream, gelato, or any other frozen food product.

### 4. Pre-Packaged Food Storage and Preparation Vessel

The vessel 100 is configured to store a volume of frozen yogurt base 170 and functions as a container in which the volume of frozen yogurt base 170 is mixed, beaten, and cooled with a fresh milk product to produce a serving of frozen yogurt. The vessel 100 can include any combination of frozen food components (e.g., sugar, yogurt cultures, fruit etc.) of varying qualities and percent compositions in a freeze-dried mixture. For example, the vessel 100 can include a freeze-dried mixture of 30% (by weight or by volume) artificial sweetener, 20% yogurt culture, and 50% fruit to produce a low-end quality frozen yogurt. In another example, the vessel 100 can include a freeze-dried mixture of 25% raw cane sugar, 50% yogurt culture, 10% milk fat, and 15% fruit to produce a high-end quality frozen yogurt. The vessel 100 further functions as a container from which the serving of frozen yogurt may be consumed directly by a user. For example, the frozen yogurt base 170 can include: dried milk solids, sweetener (e.g., sugar), milk fat, yogurt cultures, natural flavorings (e.g., freeze-dried fruit particles), and/or natural coloring. In this example, to transform the frozen yogurt base 170 into frozen yogurt, a user adds liquid—such as whole milk, low-fat milk, soy milk, almond milk, etc.—to the vessel 100 up to a fill line defined by the vessel 100 (e.g., the top of stanchion 140). Once the vessel 100 is installed in the receiver 220 in the apparatus 200, the apparatus 200 mixes the liquid and the frozen yogurt base 170 in the vessel 100 while cooling this mixture through the wall of the vessel 100 to: rehydrate some components of the frozen yogurt base 170; dissolve other components of the frozen yogurt base 170 (e.g., sugar) into the liquid; and create a low-temperature suspension of milk solids, cultures, and/or re-hydrated fruit particles, etc. in ice crystals (i.e., “frozen yogurt”).

### 4.1 Structure

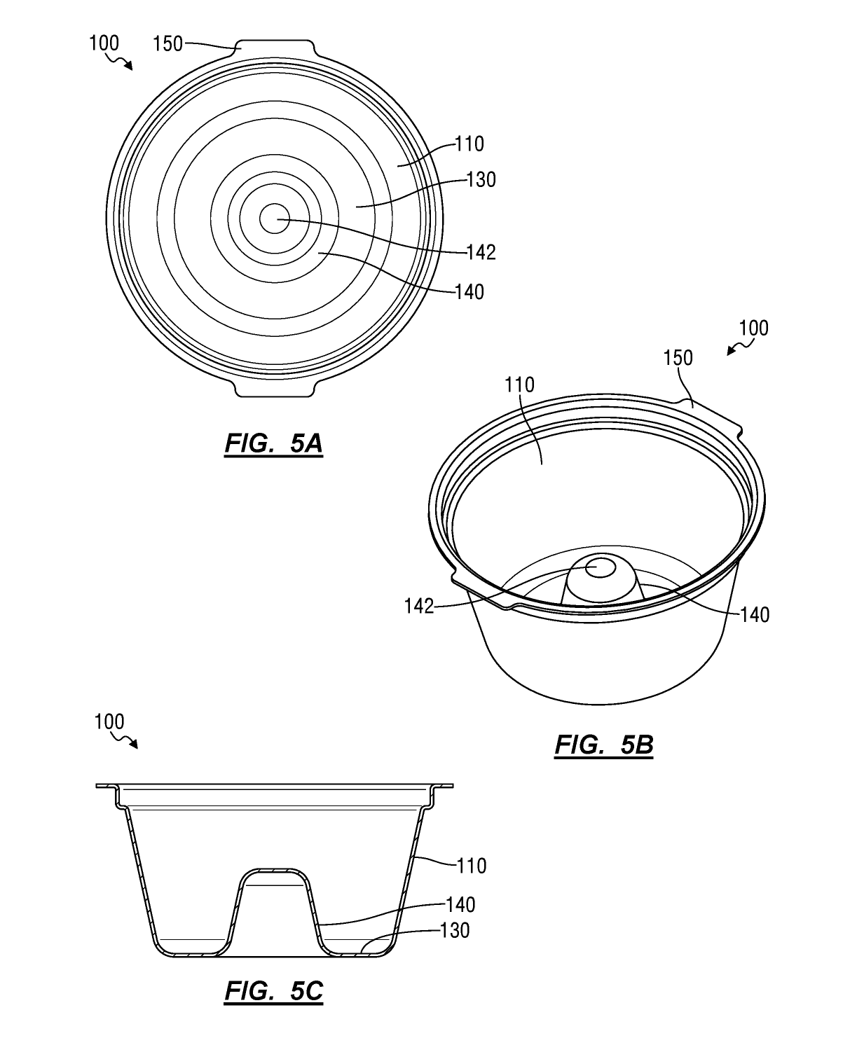

As shown in FIGS. 5A, 5B, and 5C, the vessel 100 defines a unitary structure including: an outer wall 110 comprising a first frustoconical section defining a central axis and declined toward the central axis; a base 130 extending from a lower edge of the outer wall 110 toward the central axis; and a stanchion 140 defining a second frustoconical section axially aligned with the central axis, inclined from the base 130 toward the central axis, and defining a shelf 142 offset below the upper edge of the outer wall 110. Generally, the structure is symmetric about the central axis and supports rotation of the beater 120 about the central axis such that the beater 120 can scrape the interior surfaces of the outer wall 110, base 130, and stanchion 140.

In one implementation, the outer wall 110 of the vessel 100 is tapered downward toward its central axis and terminates in the base to form a frustoconical section. For example, the outer wall 110 of the vessel 100 can define a thin, straight cross-section declined at a draft angle of 15° toward the central axis of the vessel 100 and swept radially about the central axis of the vessel 100 to form a 30° cone angle. However, the vessel 100 can define any other draft angle (or “conical angle”) such as between 0° and 15°. In particular, the outer wall 110 of the vessel 100 can define a tapered (or “drafted,” or “conical”) geometry configured to mate with the receiver 220 in the apparatus 200 such that a substantially large portion of the exterior surface of the outer wall 110 contacts the internal surface of the receiver 220, thereby achieving high thermal contact and thermal conductivity between the vessel 100 and the receiver 220. Because the outer wall 110 of the vessel 100 defines a conical section, the vessel 100 inherently seats and centers in the receiver 220; as described below, the drive unit weights the beater 120, which further depresses the vessel 100 into the receiver 220 and improves thermal contact between the vessel 100 and the receiver 220. However, the outer wall of the receiver 220 defines a conical angle sufficiently wide to prevent the outer wall 110 of the vessel 100 and the interior surface of the receiver from binding; that is, the outer wall 110 of the vessel 100 mates with the receiver 220 according to a self-releasing taper interface.

To prevent rotation of the vessel 100 in the receiver 220 while the apparatus 200 drives the beater 120, the vessel 100 further includes a rim 150 that extends from the rim of the outer wall 110 and engages a receptacle, slot, or other lock feature above the receiver 220, as shown in FIGS. 1 and 5B. When the vessel 100 is inserted into the receiver 220, a serrated or stepped edge of the rim 150 can engage a like feature extending from the receiver 220, which can prevent the vessel 100 from rotating within the receiver 220. Alternatively, the apparatus 200 can include a tab extending from the receiver 220 and configured to engage a like feature on the vessel 100 to prevent rotation of the vessel 100 within the receiver 220 during a processing cycle.

In one variation, the outer wall 110 of the vessel 100 defines a conical angle configured to wedge into and to bind against the receiver 220; that is, the outer wall 110 of the vessel 100 can mate with the receiver 220 according to a self-holding taper interface. In this variation, the drive unit can drive the vessel 100 into the receiver 220 to ensure sufficient binding between the vessel 100 and the receiver 220 to prevent rotation of the vessel 100 during operation of the apparatus 200. In this variation, the apparatus 200 can include a plunger arranged in the receiver 220 and configured to drive the vessel 100 upward, thereby releasing the vessel 100 from the receiver 220. For example, the plunger can be manually or electromechanically actuated upon completion of a processing cycle; when actuated, the plunger can drive the stanchion 140 upward, thereby deforming the base 130 of vessel 100, drawing a portion of the outer wall 110 of the vessel 100 inward and away from the adjacent surface of the receiver 220, and eventually releasing the vessel 100 from the receiver 220. In this example, the plunger can also hold the vessel 100 offset above the receiver 220 (e.g., by ˜0.10″) until the vessel 100 is removed from the apparatus 200.

The base 130 defines a “bottom” of the vessel 100 and extends from the outer wall 110 toward the central axis of the vessel 100 and terminates at the stanchion 140. The stanchion 140 defines a frustoconical riser centered on the central axis of the vessel 100, extending above the base 130, and terminating in a shelf 142 offset below the rim of the outer wall 110. The shelf 142 defines a bearing surface that vertically supports the beater 120 against the driveshaft during a processing cycle. The shelf 142 also extends up to and/or (slightly) above the liquid fill line for the vessel 100 such that powdered frozen yogurt base 170 and added liquid are not trapped and frozen between the beater 120 and the shelf 142 during a processing cycle. In particular, the beater 120 functions to scrape ice crystals from the interior wall of the vessel 100, but the scraping efficiency of the beater 120 may decrease if material buildup occurs between the drive coupling 122 of the beater 120 and the stanchion 140, such as ice crystals and rehydrated fruit particles that may raise the beater 120 within the vessel 100 and offset the paddles from the wall of the vessel 100; the stanchion 140 can therefore define the shelf 142 above the liquid fill line in order to substantially isolate the interface between the shelf 142 and the drive coupling 122 of the beater 120 from wet and dry food products in the lower volume of the vessel 100. The stanchion 140 can taper upwardly toward the central axis of the vessel 100 to form a conical angle substantially identical to that of the outer wall 110 of the vessel 100 (e.g., 30°). However, the stanchion 140 and the outer wall 110 of the vessel 100 can form any other similar or dissimilar conical angle(s).

In one variation, the vessel 100 defines a unitary structure including: an outer wall 110 comprising a first frustoconical section defining a central axis and declined toward the central axis; a base 130 extending from a lower edge of the outer wall 110 toward the central axis; and a convex semispherical dimple axially aligned with the central axis on the base 130. In this variation, the dimple functions as a short stanchion that constrains the beater 120 coaxially within the vessel 100 before the beater 120 engages with the driveshaft and guides blades of the beater 120 around the dimple while the beater 120 is engaged with the driveshaft.

The vessel 100 can also define a fillet between the outer wall 110 and the base 130 and between the base 130 and the stanchion 142. In this implementation, the fillets can be sized to enable tips of spoons of common geometries to be manipulated into and across the fillet. For example, each fillet can define a fillet radius of 0.375″. The external wall of the vessel 100 can also define a stack ring proximal its top edge (i.e., opposite the base). For example, the external wall of the vessel 100 can define a 0.15″ by 0.15″ step with shallow draft angle (e.g., ˜2°) offset 0.10″ below the rim of the vessel 100 and configured to vertically offset a second vessel 100 stacked above.

The outer wall 110, base 130, and stanchion 140 of the vessel 100 can define a unitary structure of a substantially thermally conductive material. For example, the outer wall 110, base 130, and stanchion 140 can be stamped, drawn, hydro-formed, or spun from aluminum sheet between 0.020″ and 0.050″ thick; following stamping, drawing, or spinning, the rim of the structure can be punched or laser-cut to form one or more tabs, as described above. However, the structure of the vessel 100 can define any other geometry or feature and can be of any other material formed in any other way.

In one variation, the vessel 100 includes an inert coating applied to the interior surface of the vessel 100. For example, the interior surface of the vessel 100 can be coated with a transparent or translucent polyester coating to prevent contents 180 of the vessel 100 from reacting with the bare aluminum on the interior surface of the vessel. However, the interior surface of the vessel 100 can be coated with any other material suitable for preventing the contents 180 of the vessel 100 from reacting with the base material (e.g., aluminum) of the vessel 100 during a processing cycle, which may otherwise give the completed frozen food product a metallic taste.

### 4.2 Beater

As shown in FIG. 1, the beater 120 defines a loose member arranged inside the vessel 100, supported by the stanchion 140, and configured to scrape dry and wet food product from the interior surfaces of the vessel 100 during a processing cycle. In particular, the beater 120 includes: a drive coupling 122 arranged over the shelf 142 and configured to rotate about the central axis; a first blade 126 extending from the drive coupling 122, down an inclined surface of the frustoconical stanchion 140, along the base 130, and up a portion of the outer wall 110; and a second blade 126 radially offset from the first blade 126 and extending from the drive coupling 122, down an inclined surface of the frustoconical stanchion 140, along the base 130, and up a portion of the outer wall 110. The beater 120 can include an additional blade 126, such as a total of three blades spaced radially and equidistant about the drive coupling 122.

In one implementation, the drive coupling 122 defines an internal or external spline configured to mate with an externally- or internally-splined end of the driveshaft of the apparatus 200. The drive coupling 122 of the beater 120 can define an internal or external tapered splined tip declining toward the top of the drive coupling 122 allowing the externally- or internally-splined end of the driveshaft to mate with the driveshaft vertically and radially as the driveshaft is lowered to engage with the beater 120. However, the drive coupling 122 of the beater 120 can define any other form or geometry configured to mate with an inverse form of the drive coupling of the driveshaft.

In one implementation, the beater 120 includes a pair of blades 126 extending from the drive coupling 122 and radially offset by 180° about the drive coupling 122. Each blade 126 can define a wide, short scraper cross-section swept along a path corresponding to the interior surfaces of the stanchion 140, base 130, and outer wall 110 of the vessel 100. In particular, each blade 126 can include three linear sections separated by two arcuate sections, wherein a first linear section runs along the conical section of the stanchion 140, a first arcuate section runs along an inner fillet between the stanchion 140 and the base 130, a second linear section runs along the planar section of the base 130, a second arcuate section runs along an outer fillet between the base 130 and the outer wall 110, and a third linear section runs along the conical section of the outer wall 110.

In the foregoing implementation, the ends of the first and third linear sections of each blade 126 can be stretched outwardly such that blades 126 elevate the drive coupling 122 off of stanchion 140 (i.e., separating the drive coupling 122 from the shelf 142) when at rest. However, upon engaging the drive coupling 122, the driveshaft can depress the drive coupling 122 onto the shelf 142, thereby deforming and compressing edges of the blades 126 against the interior surface of the vessel 100 such that the blades 126 can scrape ice crystals off the vessel 100 during a processing cycle.

Each section of each blade 126 can thus scrape ice crystals from interior surfaces of the vessel 100 as the apparatus 200 cools the vessel 100 during a processing cycle, thereby preventing collection of ice crystals on the vessel 100 and preventing growth of larger ice crystals that may otherwise worsen the mouth feel and texture of frozen yogurt within the vessel 100 upon conclusion of the processing cycle. When rotated, the blades 126 also cooperate to draw ice crystals formed on the wall of the vessel 100 toward the center of the vessel 100 such that these ice crystals may mix with and cool other contents 180 of the vessel 100.

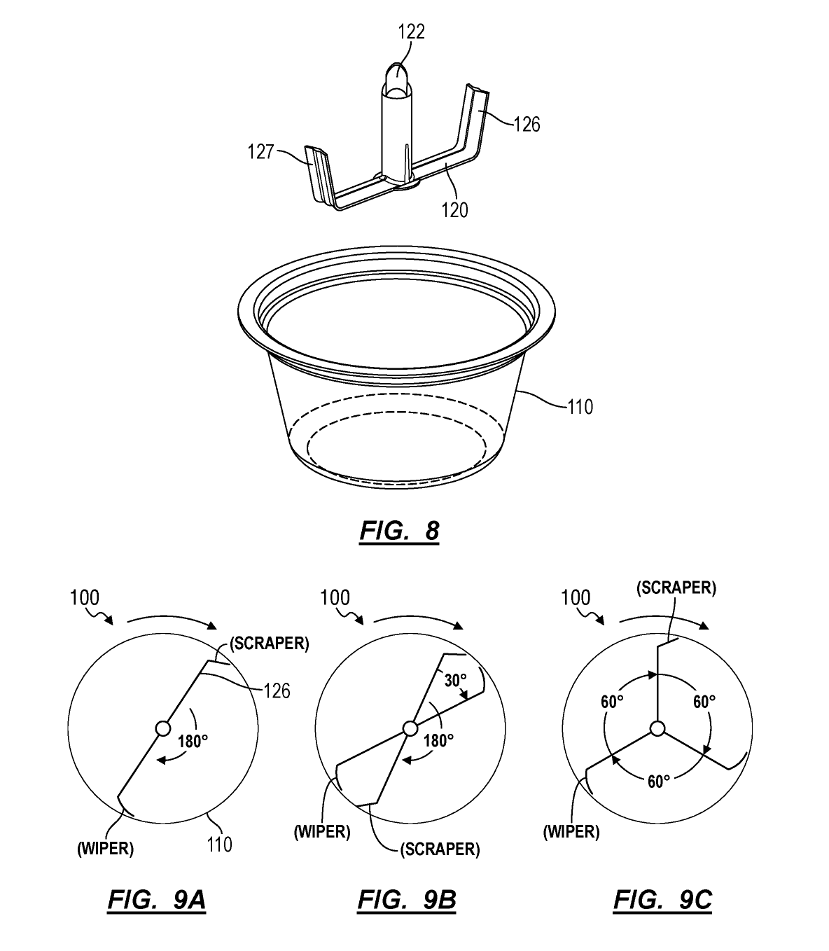

In one implementation, the beater 120 includes a wiper blade extending substantially vertically along the interior wall of the vessel 100 and extending laterally along the interior wall of the vessel 100 counter to the direction that the driveshaft rotates the beater 120, such that the wiper blade deposits (or “wipes”) contents onto the interior wall of the vessel 100 as the beater 120 rotates, as shown in FIG. 8. The wiper blade can include tabs that ride on the interior wall of the vessel 100 to set and maintain an offset (e.g., 0.1″) between the wiper blade and the interior wall of the vessel 100. The beater 120 can also include a scraper blade extending substantially vertically along the interior wall of the vessel 100 and extending laterally along the interior wall of the vessel 100 in the direction that the driveshaft rotates the beater 120, such that the scraper blade scrapes the contents off of the interior wall of the vessel 100 and pushes the contents toward the bulk contents 180 of the vessel 100 as the beater 120 rotates. The wiper blade and the scraper blade can be radially offset about the drive coupling 122 by any angle to allow contents 180 of the vessel 100 to be wiped onto the interior wall of the vessel 100 and remain there for a desired amount of time before being scraped away from the interior wall of the vessel 100 and pushed back toward the bulk contents 180 of the vessel 100.

In one example of the foregoing implementation, the wiper blade and the scraper blade can be offset by 180° about the drive coupling 122, creating a symmetrical arrangement of the blades 126 when viewed down the axis of the drive coupling 122, as shown in FIG. 9A. In another example, the wiper blade and the scraper blade can be offset by 60° about the drive coupling, creating an asymmetric arrangement of the blades 126 when viewed down the axis of the drive coupling 122. In this example, the beater 120 can include two or more pairs of wiper and scraper blades 126. The symmetrical, 180° offset arrangement of the blades 126 allows contents 180 of the vessel 100 to remain in contact with the interior wall of the vessel 100 approximately three times longer than the asymmetrical, 60° offset arrangement of the blades 126 when rotating at approximately the same angular speed. The 180° offset arrangement of the blades 126 thus allows the contents 180 of the vessel 100 approximately three times as much time to transfer heat to the interior wall of the vessel 100 and freeze than does the 60° offset arrangement of the blades 126.

In the foregoing implementation, the beater 120 can include any combination of wiper blades and scraper blades to achieve a desired internal cycling of the contents 180 of the vessel 100 and maintain a balance of the beater 120. For example, the beater 120 can include a wiper blade, a first scraper blade radially offset from the wiper blade by 60°, and a second scraper blade radially offset from the first scraper blade by 60°, as shown in FIG. 9C. In another example, the beater 120 can include a first wiper and scraper blade pair in which the wiper blade and scraper blade are radially offset by 30° and an identical second wiper and scraper blade pair radially offset from the first wiper and scraper blade pair by 180°, as shown in FIG. 9B.

In one example, the beater 120 can include an injection-molded, disposable polymer, such as a fiber-filled food-safe nylon. However, the beater 120 can define any other suitable geometry of any other material and including any other number of blades 126.

### 4.3 Seal

As shown in FIG. 1, the vessel 100 also includes a seal 160 that, when in place over the interior volume of the vessel 100, seals the dry frozen yogurt base contained therein from air, humidity, light, and dirt ingress. In one implementation, the seal 160 includes a metallic (e.g., aluminum) foil sheet bonded to a rim of the vessel 100 with a time, temperature, pressure, and/or UV-curable and food-safe adhesive. To prepare the vessel 100 for processing, a user can thus peel the seal 160 from the vessel 100, add milk (or other fluid) to the vessel 100, and then install the vessel 100 in the receiver in the apparatus 200.

In one variation, the seal 160 includes a transparent or translucent polymer film applied across the rim of the vessel 100, and the driveshaft is configured to pass through the seal 160 to engage the drive coupling 122 on the beater 120. The seal 160 can thus prevent liquid from escaping the vessel 100 during a processing cycle but can also—by nature of its translucency—enable a user to view transition of contents 180 of the vessel 100 from liquid to frozen during the processing cycle. For example, the driveshaft can be configured to pierce the translucent seal 160 at the beginning of a processing cycle. Alternatively, the vessel 100 can include a secondary (translucent or opaque) seal over the center of the (primary) seal 160; a user can remove the secondary seal to expose an opening in the primary seal 160 coincident the central axis of the vessel 100, pour liquid into the vessel 100 through the opening, and then install the vessel 100 into the apparatus 200. In this example, the driveshaft can thus pass through the opening in the primary seal 160 to engage the drive coupling 122, and the primary seal 160 can remain in place over the path of the tips to prevent splatter of food product from the tips of the blades 126 during the subsequent processing cycle.

However, the seal 160 can include any other material of any other geometry transiently (i.e., removably) installed across the rim of the vessel 100. For example, the seal 160 can alternatively include a foil-backed, polymer-impregnated paper lid. Furthermore, in the implementation described above in which the vessel 100 includes one or more tabs 150, the seal 160 can extend over but remain separate from (i.e., unbounded to) the rim 150; the rim 150 can thus function to enable a user to grab and peel the seal 160 from the rim of the vessel 100, and the rim 150 can also function to constrain the vessel 100 from rotation in the receiver during a subsequent processing cycle.

The vessel 100, beater 120, and seal 160 can thus define a single container in which the frozen yogurt base 170: is stored; then, when ready for consumption, is mixed with liquid, cooled, and beaten to create a volume of frozen yogurt; and finally consumed by a user. Once the volume of frozen yogurt is consumed, the vessel 100 and beater 120 (along with the seal 160) can be discarded (e.g., recycled). With the vessel 100 and beater 120, all cleanup is similarly discarded, thereby necessitating no further cleanup of the apparatus 200.

Alternatively, the vessel 100 and beater 120 can be reusable. For example, after a first use in which the seal 160 is peeled from the vessel 100 and discarded, the beater 120 and vessel 100 can be washed. To reuse the beater 120 and vessel 100, a user can insert the beater 120 into the vessel 100, dispense a packet of dry frozen yogurt base 170 into the vessel 100, add a liquid to the vessel 100, and place the vessel 100 into the apparatus 200. The apparatus 200 can then process the contents 180 of the vessel 100, as described above.

### 5. Apparatus

Generally, the apparatus 200 includes functions to receive a vessel 100—including a volume of frozen yogurt base and loaded with a volume of fresh milk or other liquid—and to execute Blocks of the method S100 to cool the vessel 100 and rotate the beater throughout a processing cycle in order to transform the frozen yogurt base and fresh milk into a volume of fresh frozen yogurt, as shown in FIGS. 2A, 2B, and 3.

### 5.1 Receiver

The apparatus 200 includes a receiver 220 that defines an internal frustoconical section of a thermally conductive material configured to transiently receive the vessel 100. Generally, the receiver 220 defines an internal geometry matched to the exterior geometry of the vessel 100 such that, when the vessel 100 is installed in the receiver 220, the interior surface of the receiver 220 mates with (i.e., contacts) the exterior surface of the outer wall. In particular, the receiver 220 can define an internal frustoconical section characterized by a conical angle substantially identical to a conical angle of the outer wall of the vessel 100 in order to achieve persistent thermal contact between the receiver 220 and the vessel 100 during a processing cycle.

The receiver 220 also includes a mass of thermally-conductive material that defines the internal section of the receiver 220. As described below, the refrigeration unit 240 can cool the receiver 220, and the thermally-conductive mass of the receiver 220 can conduct thermal energy (i.e., heat) out of the vessel 100—and thus out of the contents of the vessel 100—and into the refrigeration unit 240 that moves this heat to another region of the apparatus 200 and that releases this heat to ambient during a processing cycle. The receiver 220 can define a substantially minimal thermal mass in order to: limit a duration of time and power necessary to cool the receiver 220 to a target temperature (e.g., −50° C.) during a processing cycle; and limit a duration of time over which the receiver returns to a touchable temperature following removal of the vessel 100 from the receiver 220 upon completion of the processing cycle.

In one implementation, the receiver 220 further includes a frustoconical pedestal that extends upwardly from the center of the receiver 220. In this implementation, when the vessel 100 is inserted into the receiver 220, the pedestal contacts and vertically supports the stanchion at the center of the vessel 100 against depression by the driveshaft. The pedestal can also function to conduct heat from the stanchion—and therefore from contents in the vessel 100—into the refrigeration unit 240; the pedestal can therefore be of a thermally-conducive material (e.g., aluminum) and can define a frustoconical geometry substantially matched to the geometry of the stanchion. For example, the receiver 220 can include a unitary cast or spun aluminum structure that defines both a declined, frustoconical section configured to contact the exterior surface of the outer wall of the vessel 100 and a pedestal inclined upwardly from the center of the receiver 220 to contact an outer surface of the stanchion when the vessel 100 is installed in the receiver 220.

In the foregoing implementation, the pedestal can be arranged within the receiver 220 such that, when the vessel 100 is initially placed in the receiver 220, the top of the pedestal is offset below the back side of the shelf of the stanchion opposite the beater (e.g., by ˜0.050″) and the conical side of the pedestal is offset inwardly from the adjacent exterior surface of the stanchion (e.g., by ˜0.025″). Thus, when the drive unit in the apparatus 200 depresses the stanchion downward into the receiver 220, the stanchion can seat over the pedestal and the outer wall of the vessel 100 can seat onto the receiver 220, thereby achieving greater thermal contact between exterior surfaces of the vessel 100 and interior surfaces of the receiver 220. Furthermore, in the variation described above in which the outer wall of the vessel 100 and the receiver 220 mate according to a self-holding taper interface, the pedestal can function like the plunger described above to elevate the vessel 100 out of the receiver 220.

In one implementation, the receiver 220 includes a cast, machined, or spun aluminum structure, and the interior surfaces of the receiver 220 can be clear-anodized in order to limit wear of the receiver 220 over time, thereby maintaining a high degree of thermal conductivity between the receiver 220 and a vessel placed therein over a large number of cycles. Alternatively, the receiver 220 can include a spun copper structure that is then oxidized to improve the thermal emissivity of the receiver 220. However, the receiver 220 can include any other material formed and processed in any other way to form a structure configured to receive and to conduct thermal energy out of a vessel 100 during a processing period.

### 5.2 Drive Unit

The apparatus 200 further includes a drive unit, such as including a rotary motor 280 arranged over the receiver 220 and a driveshaft 230 coupled to the rotary motor 280 and configured to transiently engage a beater arranged within a vessel 100 residing in the receiver 220. Generally, the driveshaft 230 functions to engage a beater within a vessel 100 during a processing cycle, and the driveshaft 230 functions to rotate the beater at various speeds according to Blocks S110, S120, and S130 to transform the contents of the vessel 100 into frozen yogurt and according to Block S140 to maintain the contents of the vessel 100 in a frozen yogurt state.

The rotary motor 280 can include a rotary DC motor, a stepper motor, a servo motor, a gearhead motor, or any other suitable type of standalone rotary motor or rotary motor with integrated gearbox configured to apply a torque to the driveshaft 230. The rotary motor 280 can also include an encoder (e.g., an optical encoder) coupled to its output shaft, and the apparatus 200 can read the optical encoder during a processing cycle to track the angular speed of the driveshaft 230 and then implement closed-loop feedback controls to achieve various target angular speeds of the driveshaft 230. The rotary motor 280 can also include an ammeter to sample and monitor the current through or the voltage drawn by the rotary DC motor. However, the rotary motor 280 can include any other type of actuator, and the apparatus 200 can control the rotary motor 280 in any other any suitable way.

The drive unit can also include a spring coupling 232 interposed between the driveshaft 230 and the rotary motor 280 and configured to absorb distance variations between the rotary motor 280 and the beater and to thrust the driveshaft 230 toward the beater. In one implementation, the drive unit includes a contact sensor 234 coupled to the spring coupling 232 and configured to output a signal corresponding to depression of the driveshaft 230 toward the rotary motor 280. A controller included in the apparatus 200 can sample the contact sensor 234 and confirm correct engagement between the driveshaft 230 and the beater based on an output of the contact sensor 234 and transition the rotary motor 280 from a rest state to a first target angular speed in response to confirmation of correct engagement between the driveshaft 230 and the beater.

### 5.2.1 Telescoping Driveshaft

In one implementation, the driveshaft 230 includes a telescoping shaft including a splined end and coupled to the rotary motor 280 at an opposite end. In this implementation, the apparatus 200 can include a secondary actuator (e.g., a rotary or linear motor) configured to advance the driveshaft 230 toward the receiver 220 at the beginning of a processing cycle and configured to retract the driveshaft 230 upon completion of the processing cycle.

In one example, the apparatus 200 also includes a transparent door ahead of the receiver 200, a position sensor on the door, and a “Start” button. In this example, when the door is closed, the “Start” button selected, and an output of the temperature sensor changes (indicating that a mass—such as a vessel 100—has been inserted into the receiver 220), the apparatus 200 can trigger the secondary actuator to advance the driveshaft 230 downward. When a current draw of the secondary actuator increases, thus indicating that the driveshaft 230 has reached an object, the apparatus 200 can trigger the rotary motor 280 to ramp to the first speed in Block S102. The secondary actuator can continue to drive the driveshaft 230 downward for a limited period of time (e.g., 5 seconds) or over a limited number of revolutions of the driveshaft 230 (e.g., 2 revolutions) to ensure that the end of the driveshaft 230 properly engages the beater in the vessel 100; once proper driveshaft 230 engagement is confirmed, the apparatus 200 can deactivate the secondary actuator. Upon completion of the processing cycle, the apparatus 200 can maintain the position of the driveshaft 230, and the rotary motor 280 can continue to apply a torque to the driveshaft 230 to rotate the beater at a fourth (i.e., relatively slow) angular speed. However, when the door is later opened, the secondary actuator can retract the driveshaft 230 to enable a user to remove the vessel 100 from the receiver 220.

In the foregoing example, following selection of the “Start” button, to confirm that a vessel 100 has been inserted into the receiver 220, the apparatus 200 can activate the refrigeration unit 240 and then sample the temperature sensor; if the temperature sensor immediately outputs a signal indicating a drop in temperature of a surface in its field of view, the apparatus 200 can determine that a vessel 100 has not be inserted into the receiver 220. However, if the temperature sensor does not indicate a substantial change in the temperature of a surface in its field of view, such as not greater than a preset threshold temperature change, within a limited period of time following activation of the refrigeration unit 240, the apparatus 200 can determine that a thermal mass (e.g., a vessel 100) is obscuring the temperature sensor's view of the receiver 220 and then initiate the processing cycle accordingly.

Alternatively, the driveshaft 230 can be manually advanced and retracted at the beginning and end of a processing cycle. For example, the driveshaft 230 can include a telescoping shaft rigidly coupled at one end to an output shaft of the rotary motor 280 (or of an adjacent gearbox), and the user can draw the driveshaft 230 downward toward the vessel 100 to engage the end of the driveshaft 230 and the drive coupling on the beater. Alternatively, the driveshaft 230 can define a rigid shaft configured to slide vertically along a splined coupler driven by the rotary motor. In this implementation, the user can draw the driveshaft 230 through the splined coupler to engage the end of the driveshaft 230 with the beater.

### 5.2.2 Fixed Driveshaft

In one variation, the drive unit includes a lid 260 arranged over the receiver 220, pivotably coupled to the base, and operable in an open position 261 and a closed position 263; a rotary motor 280 arranged within the lid 260; a driveshaft 230 coupled to the rotary motor 280 and configured to transiently engage a beater arranged in the frustoconical vessel 100 with the lid in the closed position 263; and a window 270 extending from the lid 260 and configured to depress the frustoconical vessel 100 into the receiver 220 with the lid in the closed position 263. Generally, in this variation, the lid 260, rotary motor 280, driveshaft 230, and window 270 pivot together relative to a base 202 of the apparatus 200 to control access to the receiver 220. In particular, a user can open the lid 260 in preparation for inserting a fresh vessel 100 into the receiver 220, close the lid 260 in preparation to process, and open the lid 260 to retrieve the finished frozen yogurt product. For example, when pivoted into the open position 261, the lid 260 can extend upward and away from the receiver 220; when pivoted downward into the closed position 263, the driveshaft 230 sweeps downward to engage with the beater in a vessel 100 currently placed in the receiver 220.

The drive unit can further include a fixed driveshaft 230 coupled to the lid 260 and extending perpendicularly from the lid 260, such that, when the lid 260 is pivoted into the closed position 263, the fixed driveshaft 230 extends downward toward the receiver 220 along the center axis of the receiver 220 defined by the internal frustoconical section of the receiver 220. The fixed driveshaft 230 includes an externally- or internally-splined end and is additionally coupled to the rotary motor 280 at an opposite end. In one implementation, the externally- or internally-splined end tapers inward toward the tip of the driveshaft 230 to effectively mate with an internally- or externally-splined tip of the drive coupling of the beater vertically and radially as the lid 260 is pivoted from the open position 261 to the closed position 263 and the vessel 100 is placed in the receiver 220.

In one implementation, the drive unit also includes a spring coupling 232 interposed between the fixed driveshaft 230 and the rotary motor 280. While the lid 260 is pivoted from the open position 261 to the closed position 263, the driveshaft 230 engages with the beater at an angle, rather than from directly above. As the driveshaft 230—of fixed length—engages the beater, the spring coupling 232 accommodates for variations in the absolute distance between drive coupling of the beater and the rotary motor 280. The spring coupling 232 effectively increases the acceptance distance (i.e., maximum tolerance) for engagement between the driveshaft 230 and the beater as the lid 260 is pivoted into the closed position 263 and increases the likelihood of proper engagement between the driveshaft 230 and the beater when the beater is not fully centered within the vessel 100 or the vessel 100 is not fully centered within the receiver 220.

The tolerance required for proper engagement between the driveshaft 230 and the beater can be variable, determined in part by variations in the manufacturing of the apparatus 200 and in the vessel 100. The tolerance required for proper engagement between the driveshaft 230 and the beater can also be determined in part by the position of the beater within the vessel 100. As mentioned above, the beater is a loose member arranged inside the vessel 100 and accompanied within the vessel 100 by a powder-like volume of a frozen yogurt base 170. The position of the beater when the vessel 100 is placed into the receiver 220 can therefore vary in all three physical dimensions. For example, after being shipped to a grocery store, grabbed off of a shelf by a user, and driven home by the user, the beater may be arranged within the vessel 100 such that the drive coupling of the beater is tilted 5° away from the central axis of the vessel 100 and upraised 3 millimeters (mm) within the vessel 100 when the vessel 100 is finally placed into the receiver 220.

In one implementation, the drive unit also includes a window 270 coupled to the lid 260 and extending from the lid 260 such that the window 270 extends downward toward the base 202 of the apparatus 200 when the lid 260 is in the closed position 263. The window 270 includes a transparent structure configured to enclose the frustoconical vessel 100 and the driveshaft 230 between the base 202 of the apparatus 200 and the lid 260 when the lid is in the closed position 263. The transparent structure both prevents the user from interfering with the driveshaft 230, the vessel 100, or contents of the vessel 100 the processing cycle and contains any splatter from the contents of the vessel 100 within the apparatus 200. The transparent structure also functions to allow the user to observe the processing cycle.

In one implementation, the drive unit further includes a latch 264 configured to retain the lid 260 in the closed position 263. The latch 264 is further configured to draw the lid 260 downward toward the base 202 to depress the frustoconical vessel 100 into the receiver 220.

### 5.2.3 Thermal Contact

As mentioned above and described below, the refrigeration unit 240 can cool the receiver 220, and the thermally-conductive mass of the receiver 220 can conduct thermal energy out of the vessel 100—and thus out of the contents of the vessel 100—and into the refrigeration unit 240. To increase cooling efficiency of the receiver 220, the ratio of the surface area of the exterior surface of the vessel 100 in contact with the thermally-conductive mass of the receiver 220 to the total surface area of the exterior surface of the vessel 100 (hereinafter, “thermal contact ratio”) must be as high as possible. To this end, the apparatus 200 can depress the vessel 100 into the receiver 220.

In the variation described above in which the apparatus 200 includes a telescoping driveshaft 230, the secondary actuator can advance the telescoping driveshaft 230 downward to apply a downward force on the vessel 100 in the direction of the receiver 220 to increase the thermal contact ratio. For example, after the vessel 100 is placed into the receiver 220 and the processing cycle has been initiated (e.g., following the selection of a “Start” button by a user or the detection of the insertion of the vessel 100 into the receiver 220), the secondary actuator advances the driveshaft 230 down toward the receiver 220. The apparatus 200 can detect that the driveshaft 230 has reached an object (e.g., the beater) and that the driveshaft 230 has correctly engaged the beater by sampling a contact sensor integrated into the spring coupling 232 between the rotary motor 280 and the driveshaft 230. In response to an output of the contact sensor 234 indicating depression of the driveshaft 230 toward the rotary motor 280, the apparatus 200 can confirm correct engagement between the driveshaft 230 and the beater, and the secondary actuator can advance the driveshaft 230 further (e.g., an additional 0.1″ in the direction of the receiver 220) to transfer a downward force through the beater and onto the vessel 100 to force the vessel 100 into the receiver 220.

In the variation described above in which the apparatus 200 includes a driveshaft 230 of fixed length, a lid 260, and a window 270, the window 270 also includes a set of tabs 272 arranged on the inside of the enclosure between the base 202 of the apparatus 200 and the lid 260 defined by the apparatus 200 when the lid 260 is in the closed position 263 and configured to contact a flange on the top perimeter of the frustoconical vessel 100 and to depress the frustoconical vessel 100 into the receiver 200 when the lid 260 is in the closed position 263. The set of tabs 272 exert a downward force on the vessel 100 in the direction of the receiver 200, thereby increasing the thermal contact ratio. The set of tabs 272 can be molded into the window 270 as part of the transparent structure. For example, the set of tabs 272 can include three tabs radially offset from one another by 30°. In another example, the set of tabs 272 can include one tab spanning 180° around an internal surface of the transparent structure configured to contact the rim of the outer wall of the vessel 100.

The set of tabs 272 can transfer force from the lid 260 downward onto the vessel 100. In one example, the apparatus includes a latch 264 integrated into the lid 260 and configured to clamp the lid 260 to the base 202 of the apparatus 200 once the lid 260 is pivoted into the closed position 263 such that the tabs extending from the window supply a downward force (e.g., 20 pounds) to the rim of the vessel 100, thereby depressing the vessel into the receiver and increasing the thermal contact ratio. In this example, the latch 264 can include an electromechanical overcam latch arranged in the lid and configured to transiently engage a bolt arranged in the base to draw and lock the lid toward the base during a processing cycle. The latch 264 can alternatively or additionally be mechanically driven by a motor via a worm gear. Similarly, the latch can include an electromagnetic latch arranged in the lid and configured to magnetically couple to a ferrous element in the base to draw the lid toward the base during a processing cycle. In another example, the lid 260 is weighted (e.g., with a total weight of five pounds) above the window 270 such that the weight of the lid is transferred downward onto the rim of the vessel 100 through the set of tabs 272 when the lid 260 is in the closed position 263.

In one variation, the lid 260 includes a rigid structure extending from the lid 260 along to the window 270 (e.g., parallel to the driveshaft 230) and configured to transfer force from the lid 260 onto the rim of the vessel 100. For example, the rigid structure can include a steel rod coupled to the lid 260 and extending downward toward the receiver 220 such that the steel rod contacts the rim of the outer wall of the vessel 100 when the lid 260 is in the closed position 263. In this example, when the lid 260 is in the closed position 263, the steel rod transfers downward force from the lid 260 onto the vessel 100. The downward force exerted on the vessel 100 pushes the outer wall of the vessel 100 into the wall of the receiver 220 and thereby increases the thermal contact ratio.

In the foregoing implementations, the driveshaft can be weighted to achieve a target depression of the vessel 100 when engaged with a beater in the vessel 100. Alternatively, for the driveshaft that is automatically driven between an advanced position and a retracted position by a secondary actuator, the apparatus 200 can maintain a target current draw from the secondary actuator through a processing cycle in order to maintain a corresponding depression of the vessel 100 into the receiver. The apparatus 200 can also include a mechanical latch, a magnetic latch, or any other suitable type of latch configured to retain the driveshaft in a retracted position above the receiver, such as between processing cycles and while a vessel 100 is installed and removed from the receiver.

### 5.3 Viscosity

While preparing the frozen food product, the apparatus 200 can track a characteristic of contents of the vessel 100 correlated to viscosity. In particular, when executing the method S100, the apparatus 200 can transition between preparation stages based on a characteristic—related to viscosity—of the contents of the vessel 100. For example, the apparatus 200 can transition the rotary motor 280 from a first target speed (e.g., 150 rpm) during a cool and mix stage to a second target speed (e.g., ˜70 rpm) in a freeze stage in response to a) an indication that the contents of the vessel 100 have reached a first target temperature corresponding to a first target viscosity (e.g., 100 cP) or b) in response to a required motor torque (e.g., back EMF) necessary to maintain the first target angular speed reaching a target motor torque corresponding to the first target viscosity.

### 5.3.1 Temperature Sensor

In one implementation, the apparatus 200 also includes an optical temperature sensor arranged over and defining a field of view comprising the receiver 220. Generally, throughout a processing cycle, the apparatus 200 reads the temperature sensor and correlates outputs of the temperature sensor with temperatures of the contents of the vessel 100, which may be correlated to viscosity of the contents of the vessel 100. For example, as the contents of the vessel 100 are cooled to a freezing temperature, the contents of the vessel 100 become progressively more viscous. The apparatus 200 can thus adjust a speed of the drive unit and/or a power output of the refrigeration unit 240 based on a viscosity correlated to the temperature of the contents of the vessel 100.

In one implementation, the temperature sensor includes an infrared temperature sensor or other non-contact temperature sensor directed downward toward and defining a field of view including the receiver 220. For example, the temperature sensor can be statically mounted within the apparatus 200 adjacent a base of the driveshaft 230. Alternatively, the temperature sensor can be coupled to an end of the driveshaft 230 and can move toward the receiver 220—and therefore closer to a vessel 100 and its contents—as the driveshaft 230 is advanced downward at the beginning of a processing cycle to engage the beater in the vessel 100.

However, the temperature sensor can include any other suitable type of contact-based or non-contact sensor configured to output a signal that varies with the temperature of contents of a vessel 100 inserted in the receiver 220.

### 5.3.2 Motor Torque

In one implementation, during the processing cycle, the apparatus 200 can track (e.g., monitor) the output torque of the rotary motor required to maintain the current speed of the rotary motor. The output torque of the rotary motor can be a function of current supplied to the rotary motor, a voltage (drop) across the rotary motor, power supplied to the rotary motor, or back EMF of the motor. Alternatively, the apparatus 200 can include a torque coupling coupled to the rotary motor—such as interposed between an output shaft of the rotary motor and an adjacent end of the driveshaft—and configured to output a signal corresponding to output torque of the rotary motor; during the processing cycle, apparatus 200 can sample the torque coupling to monitor the output torque of the rotary motor.

Generally, output torque of the rotary motor can correlate to viscosity of the contents of the vessel 100. For example, as the contents of the vessel 100 are cooled to freezing, thereby progressively increasing in viscosity and further retarding motion of the beater, the rotary motor may apply greater torque to the driveshaft in order to maintain a constant rotational speed of the beater. Therefore, because output torque of the rotary motor to maintain a target beater speed is related to viscosity of the contents of the vessel (e.g., like a temperature of the contents of the vessel, as described above), the apparatus 200 can thus monitor output torque of the rotary motor (or a parameter of the rotary motor related to output torque) during a processing cycle and implement target output torque values to trigger transitions between preparation stages of the processing cycle.

### 5.3.3 Motor Power

In one implementation, the apparatus 200 can correlate the amount of power supplied to the rotary motor (hereinafter, “motor power”) to maintain the current speed of the rotary motor to a viscosity of the contents of the vessel 100. For example, in one implementation, the apparatus 200 can reference a predefined lookup table of trigger motor power values—at target speeds of the rotary motor—that define triggers for transitioning to a next stage of the processing cycle. During a preparation stage, the apparatus 200 can: implement closed-loop feedback techniques to maintain a target angular speed of the rotary motor defined for the current stage of the processing cycle; monitor the actual motor power drawn by the motor to maintain this target speed; and compare this actual motor power to the trigger motor power at the current speed of the rotary motor, as defined in the lookup table. If the actual motor power is greater than the trigger motor power for the current stage of the processing cycle, the apparatus 200 can determine that the viscosity of the contents of the vessel 100 exceed a target viscosity for the current stage and then transition to the nest stage of the processing cycle accordingly. Conversely, if the actual motor power is less than the trigger motor power for the current stage, the apparatus 200 can determine that the viscosity of the contents of the vessel 100 are still below the target viscosity to trigger transition to the next stage.

In a similar implementation, the apparatus can reference a lookup table, motor power curves, or parametric models linking motor powers at particular motors speeds to viscosities of the contents of the vessel. During a preparation stage of a processing cycle, the apparatus 200 can regularly sample the actual motor power of the rotary motor and compare the actual motor power to the lookup or motor power curve for the corresponding preparation stage or pass these actual motor powers into the parametric model to determine the viscosity of the contents of the vessel. When a target viscosity defined for the current preparation stage of the processing cycle is met, the apparatus 200 can transition to the next preparation stage. Furthermore, during a single sampling period, the apparatus 200 can sample the actual motor power of the rotary motor a number of times (e.g., 20 times), pass these actual motor powers into the lookup table or parametric model to estimate a viscosity of the contents of the vessel for each motor power reading, and then calculate a median (or mean) viscosity value from these viscosities. The apparatus 200 can then compare the median (or mean) viscosity value to a preset target viscosity for a current preparation stage and transition to a next preparation stage of the processing cycle once this target viscosity is met. In this implementation, by sampling the actual motor power multiple times, the apparatus 200 can reject noise in the detected power draw of the motor, such spikes in the motor power associated with temporary obstructions to the beater (e.g., “chunks” of dampened dry food product or ice).

The apparatus 200 can additionally or alternatively detect or otherwise monitor any other characteristic of the contents of the vessel 100 directly or by monitoring any other sensor or actuator within the apparatus to approximate a viscosity of the contents of the vessel 100.

### 5.4 Refrigeration Unit

The apparatus 200 includes a refrigeration unit 240 thermally coupled to the receiver 220. Generally, the refrigeration unit 240 functions to move thermal energy out of the receiver 220, thereby cooling the receiver 220, the vessel 100, and the contents of the vessel 100 during a processing cycle.

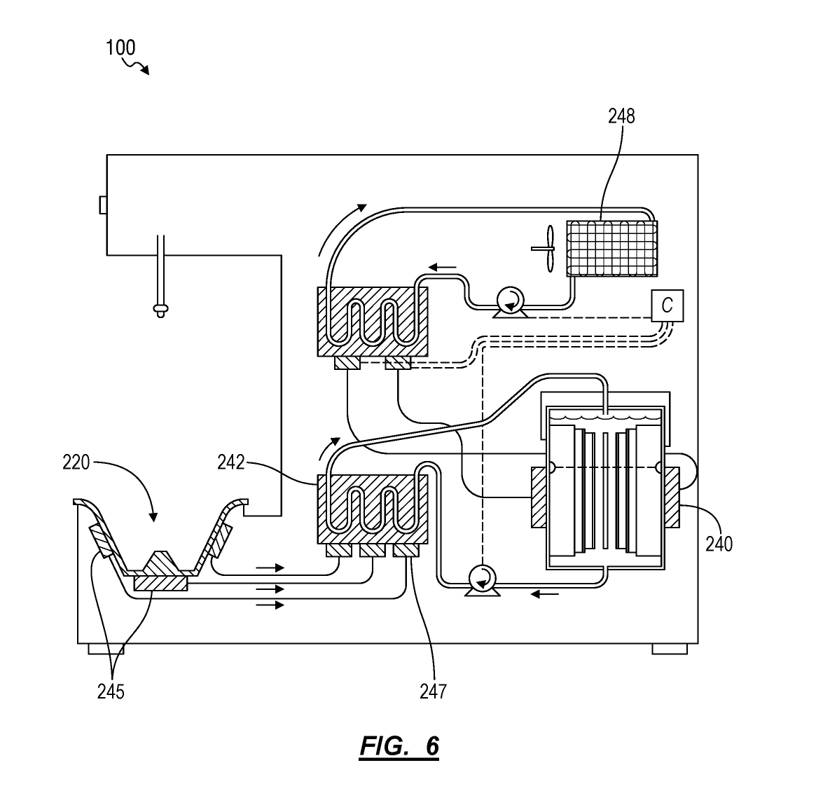

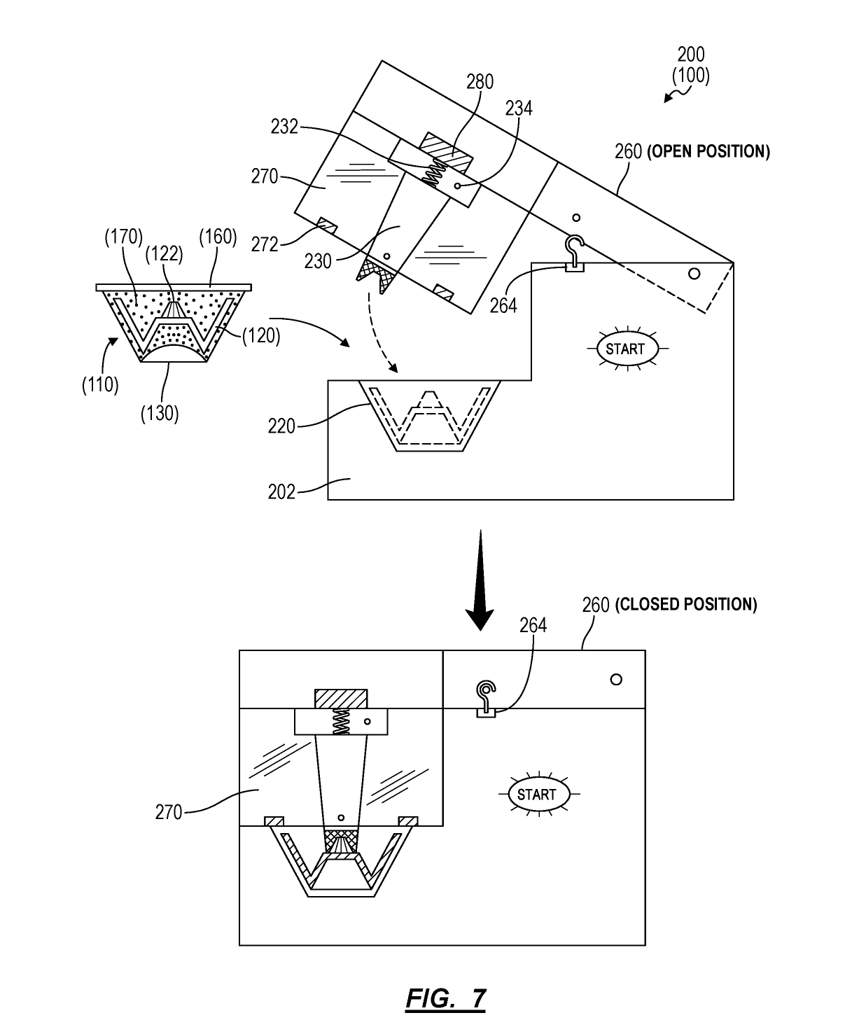

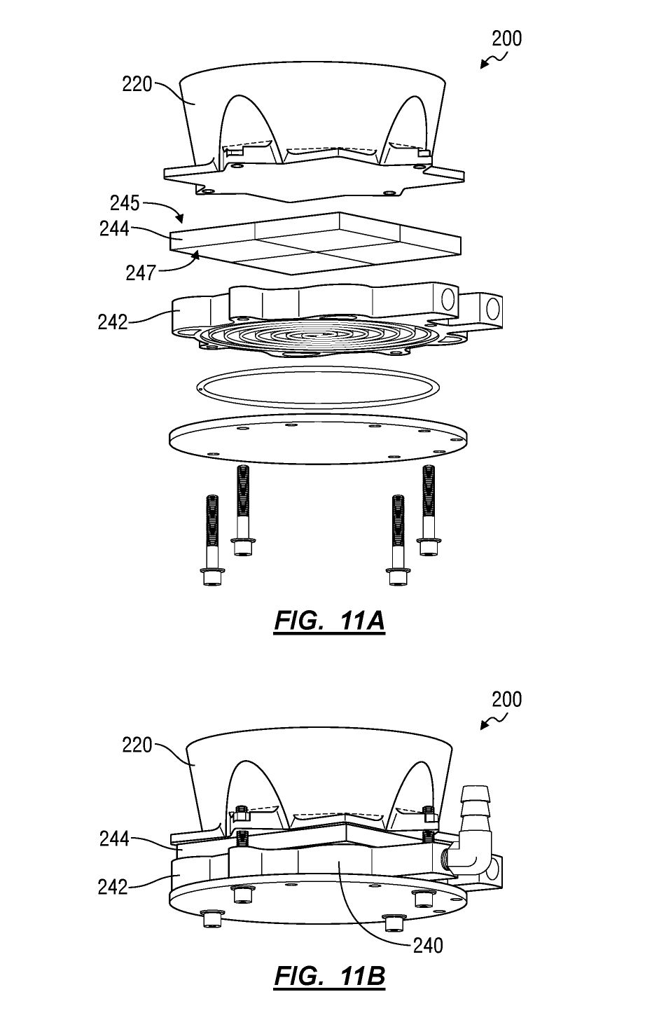

In one implementation, the refrigeration unit 240 includes a set of thermoelectric coolers 244 (“TECs”), wherein each TEC 244 includes a “hot side” and a “cold side” between the heatsink and the intercooler, which actively cools the hot sides of the TECs 244, as shown in FIGS. 11A and 11B. In this implementation, the cold sides of the TECs 244 can be mounted directly to the receiver 220 or otherwise thermally coupled to the receiver 220. For example, the refrigeration unit 240 can include four TECs 244, including a first TEC 244 with its cold side mounted to the bottom of the receiver 220 (e.g., under the pedestal), a second TEC 244 with its cold side mounted to the side of the receiver 220 at a 90° radial position, a third TEC 244 with its cold side mounted to the side of the receiver 220 at a 180° radial position, and a fourth TEC 244 with its cold side mounted to a side of the receiver 220 at a 270° radial position. The cold sides of the TECs 244 can be mounted to the receiver 220 with mechanical fasteners, such as with clips or machine screws. Alternatively, the apparatus 200 can include a sleeve (e.g., a cylindrical or conical sleeve), the receiver 220 can be installed in the sleeve, and the cold sides of the TECs 244 can be potted within the sleeve and around the receiver 220. Yet alternatively, the cold sides of the TECs 244 can be bonded to the receiver 220, such as with silver paste or with a copper-impregnated epoxy. However, the cold sides of the TECs 244 can be thermally coupled to the receiver 220 in any other suitable way. In this implementation, the hot sides of the TECs 244 can be thermally connected to a remote heat sink that releases thermal energy to ambient. For example, the refrigeration unit 240 can include an intercooler thermally coupled to the heat sink via a fluid circuit 242 (e.g., one or more fluid lines and manifolds) and a fluid pump 243 inline with the fluid circuit, as shown in FIGS. 6 and 11A. The refrigeration unit 240 can thus pump fluid (e.g., water, alcohol, a refrigerant) through the fluid circuit to cool the hot sides of the TECs 244.

In one implementation, the refrigeration unit 240 includes: a fluid manifold 242 proximal to the receiver 220; and a thermoelectric cooler 244 including a cold junction 245 thermally coupled to the receiver 220 and a hot junction 247 thermally coupled to the fluid manifold 242, shown in FIGS. 11A and 11B. In this implementation, the refrigeration unit 240 also includes: a radiator 248 fluidly coupled to the fluid manifold 242; and a pump 243 configured to pump fluid through the fluid manifold 242, as shown in FIG. 6. For example, the thermoelectric cooler 244 coupled to the receiver 220 and to the manifold 242 can absorb thermal energy from the vessel 100 when the vessel 100 is placed into the receiver 220 and transfer the thermal energy to the fluid pumped through the fluid manifold 242.

However, the refrigeration unit 240 can include any other suitable type of cooling system configured to remove heat from the receiver 220, and therefore from the vessel 100 and its contents.

### 5.5 Multi-Stage Refrigeration Unit

In one variation, the system includes a multi-stage refrigeration unit. In this variation, the refrigeration unit can include: a tank arranged within the apparatus remote from the receiver; a volume of working fluid contained within the tank; a heat exchanger fluidly coupled to the tank; a pump configured to circulate working fluid between the tank and the heat exchanger; a first set of TECs including cold sides thermally coupled to the receiver and hot sides thermally coupled to the heat exchanger; and a second set of TECs including a cold side thermally coupled to the tank. In this variation, the refrigeration unit can also include a tank sensor coupled to the tank and configured to output a signal corresponding to a quantity of frozen working fluid in the tank; and the controller can selectively enable the second set of TECs when less than a threshold quantity of frozen working fluid is contained in the tank and selectively disable the second set of TECs when more than the threshold quantity of frozen working fluid is contained in the tank based on signals received from the tank sensor.

Generally, a rate at which the first set of TECs cool the receiver during a processing cycle can be inversely proportional to the temperature of the hot sides of these TECs. Specifically, a rate at which the first set of TECs cool the receiver during a processing cycle can be proportional to a rate at which energy is transferred out of the TECs at their hot sides. For the implementation of the apparatus described above in which the refrigeration unit includes one TEC 244 stage with hot side sinking heat to ambient via a solid-air heatsink or via a radiator with circulating fluid, the rate at which heat is communicated out of the hot sides of these TECs may be a function of (e.g., limited by) ambient air temperature.

In this variation in which the refrigeration unit includes two sets of TECs arranged in series with a tank containing working fluid interposed between the first set of TECs and the second TEC (or second set of TECs), the rate at which the second TEC cools the tank and its contents can again be proportional to a rate at which energy is transferred out of the hot side of the second TEC and therefore limited by the temperature of ambient air. Furthermore, with the pump circulating working fluid from the tank to the heat exchanger, the rate at which the first set of TECs cool the receiver can again be proportional to a rate at which energy is transferred out of the hot sides of the first set of TECs and therefore limited by the temperature of the working fluid. However, prior to a processing cycle in which the first set of TECs are activated to cool the receiver, the controller can activate the second TEC in order to reduce the temperature of the working fluid in the tank, such as to a temperature below ambient air temperature or a freezing temperature of the working fluid. Thus, when the first set of TECs are activated to cool the receiver during a subsequent processing cycle, the pump can circulate cooled (or “chilled”) working fluid to the heat exchanger to cool the hot sides of the first set of TECs, thereby extracting heat from the hot sides of the first set of TECs at a more rapid rate, cooling the receiver more rapidly, and completing the processing cycle in less time. In particular, in this variation, the second TEC can function to cool working fluid in the tank prior to a processing cycle in order to a create a “cold buffer” that can later be used to cool the hot sides of the first set of TECs during a processing cycle in order to increase a rate of cooling at the receiver and to decrease a total time for the apparatus to complete the processing cycle.

In one example application, upon receipt of the apparatus, a user can place the apparatus on a kitchen counter and connect the apparatus to a power outlet. The processor can sample the tank sensor and/or a temperature sensor coupled to the tank to determine that the volume of working fluid in the tank is at a temperature above a target temperature (e.g., a freezing temperature of the working fluid). The controller can thus activate the second TEC to cool the working fluid to the target temperature despite absence of a user-entered command to begin a processing cycle. With the second TEC in operation, the controller can sample the tank sensor—such as in the form of an optical detector arranged within the tank opposite an optical emitter, as described below—and transform a signal received from the tank sensor into a transparency (or opacity) of the volume of working fluid into the tank. While all fluid in the tank is liquid, the transparency of the liquid may remain substantially unchanged from a maximum transparency (or minimum opacity) as the TEC draws thermal energy out of the tank to cool the working fluid. However, as the temperature of the working fluid in the container reaches a freezing temperature (e.g., 0° C. for water), the freezing working fluid may begin to scatter or obstruct light output from the optical emitter, thereby reducing the amount of light detected by the optical detector and altering a signal output by the optical detector. The controller can correlate this change in the signal received from the tank sensor with a proportion (e.g., percentage) of the working fluid in a solid state (i.e., frozen) in the tank, such as based on a predefined lookup table or parametric model linking analog values read from the tank sensor to corresponding proportions of frozen working fluid in the tank. When a threshold proportion (e.g., 80%) of working fluid in the tank is determined to be frozen (or when a threshold obfuscation of light output by the optical emitter is detected by the optical detector), the controller can disable the second TEC. The controller can continue to sample the tank sensor regularly, such as once per minute, and can activate the second TEC if the proportion of frozen working fluid in the tank is determined to drop below the threshold proportion (or when the optical detector detects the threshold obfuscation of light output by the optical emitter) in order to maintain a heat absorption capacity of the fluid volume in the tank in preparation for a possible future processing cycle. For example, the controller can implement closed-loop feedback techniques to selectively activate and disable the second TEC in order to reach and maintain a threshold proportion of frozen working fluid in the tank based on values regularly read from the tank sensor. Thus, in this example, the refrigeration unit can cool the contents of the tank until a threshold or target proportion of frozen working fluid is achieved in the tank, such as over a period of six hours, and maintain this proportion of frozen working fluid in the tank over time, such as until the apparatus is unplugged from the power outlet and stored. In particular, the controller can selectively activate and deactivate the second TEC to freeze some—but not all—working fluid in the tank, thereby maintaining a high heat absorption capacity of the working fluid in preparation for a processing cycle which also maintains sufficient volume of working fluid in a liquid state to enable the pump to circulate working fluid at or near its freezing temperature between the tank and the solid-liquid heat exchanger to cool the hot sides of the first set of TECs.

In the foregoing application, once the target proportion of frozen working fluid is achieved in the tank, a user can then load a vessel 100—including a volume of dry food product and a volume of liquid (e.g., water, whole milk, soy milk, etc.)—into the receiver and prompt the apparatus to begin a processing cycle. The controller can then: activate the first set of TECs to transfer thermal energy from the vessel 100 and receiver into the solid-liquid heat exchanger; and activate the pump to circulate working fluid—in liquid state at or near the freezing temperature of the working fluid—between the tank and the solid-liquid heat exchanger, thereby cooling the hot sides of the first set of TECs. Throughout the processing cycle, the controller can also maintain the second TEC in an active state in order to continue to remove thermal energy from the tank, as described above. Once the processing cycle is completed and the vessel 100 with finished frozen yogurt is removed from the receiver, the controller can disable the first set of TECs and the pump but can maintain the second TEC in an active state until the target proportion of frozen working fluid is achieved in the tank. The controller can also reactivate the first set of TECs and the pump if a second vessel 100—including another volume of dry food product and another volume of liquid—is loaded into the receiver soon after the (first) vessel 100 is removed from the receiver in order to again cool the hot sides of the first set of TECs during this second processing cycle.

The tank can therefore contain a volume of working fluid sufficient to sequentially freeze the contents of a number of (e.g., three) vessel 100s in three consecutive processing cycles. For example, for a vessel 100 containing 30 grams of dry food product and loaded with 100 grams of milk (or water, etc.) at 4.5° C., the apparatus can require approximately 250 grams of water—at 0° C. with 80% of this water frozen as ice—to absorb both sufficient thermal energy from the contents of the vessel 100 to freeze these contents into a volume of frozen yogurt and to absorb thermal energy output from the first set of TECs during the processing cycle. In this example, for the refrigeration unit to contain sufficient heat absorbing capacity to process three vessel 100s in rapid succession, the volume of working fluid can include 750 grams of water, and the controller can implement closed-loop feedback techniques, as described above, to maintain the 80% of the 750-gram volume of water as ice up until a time that a processing cycle is initiated at the apparatus. However, the working fluid can be any other type of fluid, and the refrigeration unit can include any other volume of this liquid.

The first set of TECs—including cold sides thermally coupled to the receiver and hot sides thermally coupled to the heat exchanger—functions as the first (or primary) stage of the multi-stage refrigeration unit. As described above, cold sides of the first set of TECs can be mounted directly to the receiver or otherwise thermally coupled to the receiver, and hot sides of the first set of TECs can be thermally coupled to the solid-liquid heat exchanger. For example, the first set of TECs can include four discrete TECs, including a first TEC with its cold side mounted to the bottom of the receiver (e.g., under the pedestal), a second TEC with its cold side mounted to the side of the receiver at a 90° radial position, a third TEC with its cold side mounted to the side of the receiver at a 180° radial position, and a fourth TEC with its cold side mounted to a side of the receiver at a 270° radial position. Alternatively, the first set of TECs can be arranged in a grid pattern (e.g., 2×2 grid array) with the total surface area of the first set of TECs substantially matching a surface area of the bottom of the receiver. However, the first set of TECs can include any other number of TECs with their cold sides thermally coupled to the receiver in any other way. Hot sides of the first set of TECs can be similarly mounted to one common solid-liquid heat exchanger. For example, the solid-liquid heat exchanger can include an aluminum block with an internal serpentine fluid pathway, the hot sides of the first set of TECs can be bonded (e.g., with thermal paste) to sides of the aluminum block, and the pump can pump liquid working fluid from the tank into the aluminum block, through the internal serpentine fluid pathway, and back to the tank. Alternatively, the refrigeration unit can include multiple solid-liquid heat exchangers with the hot side of one or more TECs in the first set of TECs mounted to or thermally coupled to each solid-liquid heat exchanger; the refrigeration unit can also include one pump per solid-liquid heat exchanger or a single common pump and manifold that distributes working fluid from the tank to each solid-liquid heat exchanger. However, the refrigeration unit can include any other number, type, or form of solid-liquid heat exchangers thermally coupled to the first set of TECs.

The second TEC (or second set of TECs)—including a cold side thermally coupled to the tank—functions as a second (or secondary) stage of the refrigeration unit. In one example, the second TEC includes a cold side fastened to, adhered to, or potted around the outside of the tank. As described below the hot side of the second TEC can be thermally coupled to a heat sink, such as a passive finned heatsink or to a radiator. Like the first set of TECs, the refrigeration unit can also include multiple TECs with their cold sides thermally coupled to (e.g., installed around the sides of) the tank. However, the refrigeration unit can include any other number of TECs thermally coupled to the tank in any other way.

The tank can define a closed vessel 100 of a thermally-conductive material—such as steel, aluminum, or copper—and can include internal vanes or “ribs” that function to conduct heat from within the volume of working fluid to the exterior surface of the tank and on to the cold side of the second TEC. For example, the tank can define a cylindrical vessel 100 including a set of vanes spaced radially about the interior of the tank, running parallel to the axis of the tank, and extending toward the center of the tank, wherein the vanes extend up to but not past a column defining a liquid zone along the central axis of the tank. In this example, for a four-inch diameter cylindrical tank, the tank can include twelve vanes spaced radially at 30° intervals and extending toward the center of the tank up to 0.5″ from the central axis of the tank, thereby defining a 1″-diameter liquid zone along the central axis of the tank. In this example, when the second TEC is active and drawing thermal energy out of the tank, the vanes can draw heat out of local volume of working fluid such that the working fluid begins to freeze around the vanes. However, because the vanes do not extend up to the center of the tank, working fluid within the liquid zone at the center of the tank may be the last to freeze. Furthermore, by tracking a proportion of working fluid in the tank that has frozen, as described below, and disabling the second TEC when a threshold or target proportion of frozen working fluid is detected in the tank, the controller can maintain working fluid in this column at the center of the tank in a liquid state. The tank can also include a fluid inlet at the top of the tank and centered over this column and can include a fluid outlet at the top of the tank and centered with this column (or vice versa) to enable liquid working fluid in this liquid zone of the tank to circulate to the solid-liquid heat exchanger and back into the tank when the pump is active.

However, the tank can include an inlet and an outlet at any other positions and can include any other configuration of vanes that, when cooled via the second TEC, selectively freeze local volumes of working fluid around—but not obstructing—a pathway between the inlet and the outlet. Therefore, when up to the threshold or target proportion of the volume of working fluid is frozen in the tank by the second TEC, a liquid pathway between the inlet and the outlet of the tank is preserved such that the pump can circulate working fluid between the tank and the first set of TECs. As this fluid is heated by the hot sides of the first set of TECs during a processing cycle, warmed working fluid can melt frozen working fluid around the vanes.

For example, the tank can be spun, drawn, or cast in steel, aluminum, or copper with vanes in situ, or vanes can be welded, brazed, or otherwise installed inside of the tank. The tank can also be closed on the top but not hermetically sealed in order to accommodate changes to the volume of working fluid when the working fluid changes phase. However, the tank can be of any other material or geometry and fabricated in any other way.

In this variation, the refrigeration unit can also include a heat sink thermally coupled to the hot side of the second TEC and a fan configured to actively move ambient air across the heatsink. Alternatively, the refrigeration unit can include: a second solid-liquid heat exchanger thermally coupled to the hot side of the second TEC; a liquid-air heat exchanger (e.g., a radiator including a fan that blows air through the radiator); a fluid circuit interposed between the second solid-liquid heat exchanger and the liquid-air heat exchanger; and a second pump in-line with the fluid circuit. In this implementation, the second pump can circulate fluid between the second solid-liquid heat exchanger and the liquid-air heat exchanger to cool the hot side of the second TEC, such as described above. The refrigeration unit can thus actively or passively transfer heat from the hot side of the second TEC to ambient.

In the foregoing implementation, the refrigeration unit can also include a valve (e.g., a solenoid valve) coupled to the fluid circuit and operable between a standard position and a bypass position. In particular, the valve can selectively decouple the solid-liquid heat exchanger on the hot sides of the first set of TECs from the tank and instead couple the solid-liquid heat exchanger directly to the liquid-air heat exchanger thereby bypassing the tank and the second TEC such that the hot sides of the first set of TECs can sink heat to ambient directly via the solid-liquid heat exchanger and the liquid-air heat exchanger in the bypass position. For example, if a processing cycle is initiated while the working fluid in the canister is near ambient air temperature (e.g., +/−10° F. of ambient air temperature)—such as if a processing cycle is immediately initiated once the apparatus is removed from shipping packing, if a processing cycle is immediately initiated after the apparatus is brought out of storage, or if a processing cycle is initiated following multiple preceding processing cycles that raised the temperature of the working fluid in the container to near ambient air temperature—the controller can trigger the valve to move to the bypass position to close off the tank from the solid-liquid heat exchanger and to open a fluid circuit from the solid-liquid heat exchanger to the liquid-air heat exchanger. The controller can also activate the second pump to actively circulate fluid between the solid-liquid heat exchanger and the liquid-air heat exchanger. With the valve in the bypass position, the multi-stage refrigeration unit can thus operate like the single-stage refrigeration unit described above.

As described above, the refrigeration unit can also include a tank sensor coupled to the tank and configured to output a signal corresponding to a quantity of frozen working fluid in the tank. In one implementation, the tank sensor includes an optical detector arranged on one side of the tank and defining a field of view across and substantially perpendicular to a column at the center of the tank defining a liquid zone, as described above. In this implementation, the optical detector can be paired with an optical emitter (e.g., an infrared LED, a laser diode) arranged inside the tank opposite and facing the optical detection. Throughout operation (e.g., before and during processing cycles), the controller can activate the optical emitter to illuminate working fluid within the tank and then sample the optical detector, such as at a regular sampling rate of 1 Hz or 0.1 Hz. When the working fluid is above its freezing temperature (and therefore entirely or nearly entirely liquid), a light path from the optical emitter to the optical detector may be minimally obstructed by the working fluid. However, as the working fluid freezes in a volume of the tank between the optical emitter and the optical detector, frozen working fluid may obstruct a line of sight from the optical emitter to the optical detector and scatter and/or absorb light output by the optical emitter, thereby reducing a light signal detected by the optical detector. During each sampling period, the controller can read an analog (or digital) value from the optical detector indicating a level of incident light and then compare this level of incident light to a lookup table or pass this value into a parametric model to estimate a proportion of the working fluid that is frozen in the tank. As described above, the controller can selectively enable the second TEC when less than a threshold quantity of frozen working fluid is contained in the tank and selectively disable the second TEC when more than the threshold quantity of frozen working fluid is contained in the tank based on signals received from the optical detector.

The refrigeration unit can also include a temperature sensor, such as a temperature sensor coupled to an exterior surface of the tank or in the form of a probe arranged within the tank and extending into the volume of working fluid. The controller can sample the temperature sensor to track the temperature of the working fluid over time and compare outputs of the temperature sensor and the optical emitter recorded at the same or similar times to reject noise in these sensors and/or to identify and compensate for drift in either of these sensors. However, in this variation, the refrigeration unit can include any other sensor of any other type and manipulate an output of this sensor to determine a proportion of frozen working fluid in the tank before and during a processing cycle.

### 6. Processing Cycle

Generally, the apparatus 200 implements Blocks of the method S100 to mix, beat, and cool the volume of frozen yogurt base and the added liquid throughout a sequence of preparation stages in order to create a volume of frozen yogurt directly within the vessel 100. In particular, in one implementation, the apparatus 200 transforms the frozen yogurt base and the added liquid into frozen yogurt over the course of a cool and mix stage, followed by a freeze stage, a finish stage, and then a maintenance stage within a processing cycle, as shown in FIG. 4. Throughout various stages of the processing cycle, the apparatus 200 tracks the temperature of the contents of the vessel 100, the duration of each stage, and/or the torque (or the current draw) required at the rotary motor to maintain a target angular speed of the beater; the apparatus 200 transitions between the mixing, freezing, finishing, and maintenance stages based on these variables, as shown in FIGS. 3 and 4.

At the beginning of a processing cycle, the user peels the seal from the vessel 100, adds a volume of liquid (e.g., whole milk, soy milk, etc.) to a liquid fill line in the vessel 100, inserts the vessel 100 into the receiver, and then selects a “Start” button on the apparatus 200. In response to detected selection of the “Start” button, the apparatus 200 can: sample a door sensor to determine that a door of the apparatus 200 is closed; sample the temperature sensor, a limit switch, or other sensor within the apparatus 200 to confirm that a vessel 100 has been inserted into the receiver, as described above; and/or record a baseline temperature from the temperature sensor; etc. in order to prepare for the subsequent processing cycle. Once these foregoing checks are confirmed, the apparatus 200 can drive the driveshaft into the advanced position to engage the beater within the vessel 100, as described above, and activate the refrigeration unit to begin to cool the receiver in Block S102.

With the driveshaft contacting and/or engaged with the beater and after receiving selection of the “Start” button, the apparatus 200 can set a first timer in Block S112 and can trigger the rotary motor to ramp to a first target angular speed (i.e., a target angular speed of the driveshaft and the beater) over a period of time in Block S110, as described above. Throughout the cool and mix stage, the apparatus 200 maintains the rotary motor at this first target angular speed. The apparatus 200 also samples the temperature sensor to track the temperature of the contents of the vessel 100. Once the temperature of the contents of the vessel 100 drop below a target temperature (e.g., ˜0° C.), the apparatus 200 can transition to the freeze stage. However, because the temperature sensor may exhibit some drift in its output, the apparatus 200 can delay transition from the cool and mix stage to the freeze stage until the first timer expires in order to achieve at least a minimum heat extraction from the vessel 100 during the cool and mix stage even if the temperature sensor indicates that the contents of the vessel 100 have reached a first target temperature. Similarly, if the first timer expires but the temperature sensor still indicates that the temperature of the contents of the vessel 100 have not reached the first target temperature, the apparatus 200 can delay transition into the freeze stage until the detected temperature of the contents of the vessel 100 reach the first target temperature. Because the speed of the rotary motor during the cool and mix stage may be sufficiently high to prevent formation of (longer) ice crystals in the vessel 100, an extended cool and mix stage may not substantially effect the texture of the frozen yogurt produced from the processing cycle. The apparatus 200 can therefore transition from the cool and mix stage into the freeze stage at the later of expiration of the first timer and achievement of a first target temperature in the vessel 100.

In one implementation, the apparatus 200 can sample the temperature sensor for an initial temperature and set the first timer according to the initial temperature. For example, in response to an initial temperature of 70° F., the apparatus can set the first timer for a duration of 140 seconds. In this example, in response to an initial temperature of 40° F., the apparatus can set the first timer for a duration of 100 seconds. A shorter duration of the first timer may save the apparatus 200 (and thereby, the user) time and energy during the processing cycle when the contents of the vessel 100 do not require as much cooling. The apparatus can continuously sample the temperature sensor to monitor the temperature of the contents of the vessel 100 throughout the processing cycle.

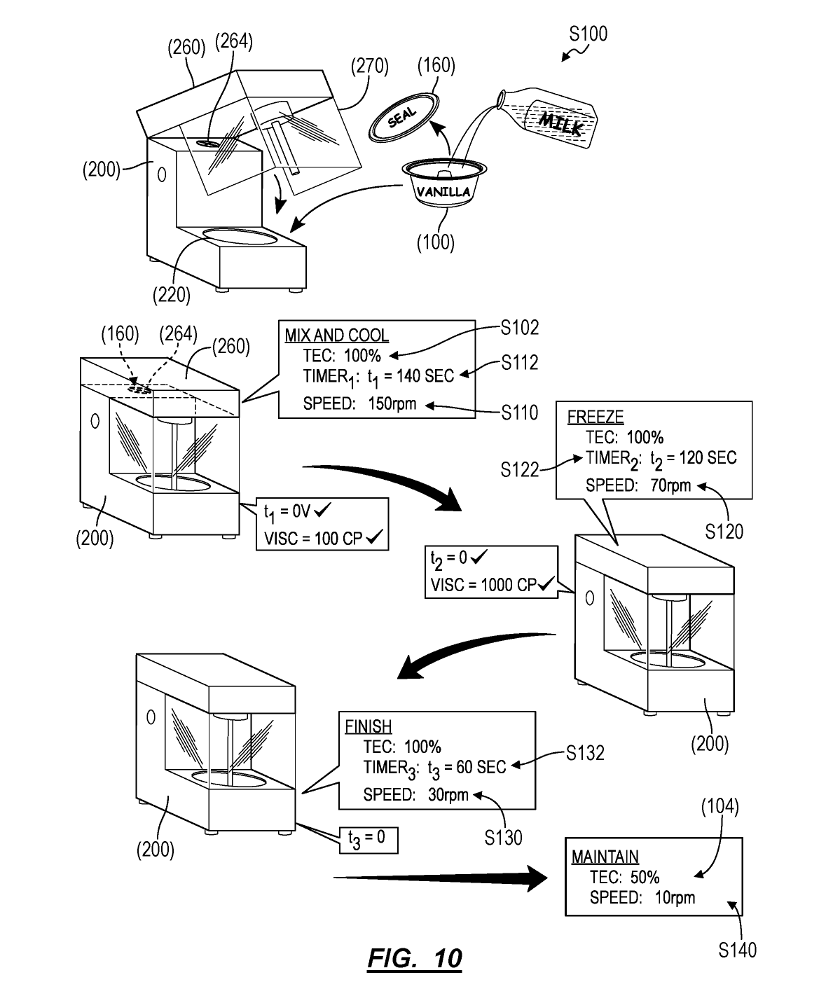

Furthermore, as the beater grinds the frozen yogurt base into the base of the vessel 100 and mixes the frozen yogurt base with the liquid, the torque output (or current draw, back EMF) of the rotary motor may reach an initial peak once the rotary motor reaches a steady-state angular speed during the cool and mix stage. As parts of the frozen yogurt base mix with the liquid and as other parts of the frozen yogurt base rehydrate, the torque output of the rotary motor may begin to drop while the angular speed of the rotary motor remains substantially constant. However, as water within the vessel 100 begins to freeze (i.e., transition from the liquid phase into the solid phase), the torque output of the rotary motor necessary to maintain the first target angular speed may begin to rise. The apparatus 200 can therefore track the torque output of the rotary motor—such as via the current draw or back EMF of the motor—throughout the cool and mix stage and can trigger transition into the freezing stage based on a torque output (or a change in torque output from an initial torque output at the beginning of the cool and mix stage) of the rotary motor. For example, the apparatus 200 can transition into the freeze stage when at least two of: expiration of the first timer, achievement of the first target temperature in the vessel 100, and achievement of a first torque output (e.g., current draw, back EMF) target of the rotary motor have occurred. In one implementation, the apparatus 200 can monitor current draw of the rotary motor and transform current draw of the rotary motor into viscosity of contents of the frustoconical vessel 100. In this implementation, the apparatus 200 can transition into the freeze stage when at least two of: expiration of the first timer, achievement of the first target temperature in the vessel 100, and achievement of a first target viscosity have occurred, as shown in FIG. 10.

Upon transitioning into the freeze stage, the apparatus 200 sets a second timer in Block S122 and reduces the angular speed of the rotary motor to a second target angular speed in Block S120 in order to enable ice crystals to form in the vessel 100. During the freeze stage, the reduced speed of the beater may allow ice crystals to form on the interior surface of the vessel 100, and the beater can scrape these ice crystals from the vessel 100 and mix these ice crystals back into the bulk volume of contents in the vessel 100. As the proportion of water in the solid phase in the vessel 100 continues to increase during the freeze stage, the torque output of the rotary motor necessary to maintain the second target angular speed may increase. The torque output of the rotary motor may also begin to level to a (more) steady-state value once substantially all of the water in the vessel 100 transitions into the solid phase. Thus, like the transition from the cool and mix stage to the freeze stage, the apparatus 200 can transition from the freeze stage into the finish stage when at least two of: expiration of the second timer, achievement of the second target temperature in the vessel 100 (e.g., 0° C., which indicates that substantially all water in the vessel 100 is now in the solid stage), and/or achievement of a second torque output target of the rotary motor have occurred. In one implementation, the apparatus 200 can transition into the finish stage when at least two of: expiration of the second timer, achievement of the second target temperature in the vessel 100, and/or achievement of a second target viscosity have occurred.

Upon transitioning into the finish stage, the apparatus 200 sets a third timer in Block S132 and reduces the angular speed of the rotary motor to a third target angular speed in Block S130 in order to continue to cool the contents of the vessel 100 and to enable longer ice crystals to form in the vessel 100, thereby achieving a target mouth feel, viscosity, and/or viscosity of the contents of the vessel 100 upon completion of the processing cycle. Throughout the finish stage, the contents of the vessel 100 continue to harden, which requires greater torque output from the rotary motor to maintain the third target angular speed from the start to completion of the finish stage. Thus, like the transition from the freeze stage to the finish stage, the apparatus 200 can transition from the finish stage into the maintenance stage when at least two of: expiration of the third timer, achievement of a third target temperature in the vessel 100 (e.g., −2.5° C.), and/or achievement of a third torque output target of the rotary motor have occurred. In one implementation, the apparatus 200 can transition to the maintenance stage when at least two of: expiration of the third timer, achievement of the third target temperature in the vessel 100, and achievement of a third target viscosity have occurred.

In one implementation, in Block S120, the apparatus reduces the angular speed of the rotary motor from the first target angular speed to the second target angular speed in response to expiration of the first timer and receipt of a first measured temperature of the contents of the vessel 100 less than a first target temperature approximating a phase-change temperature of contents of the vessel 100 and corresponding to the first target viscosity; and, in Block S130, reduces the angular speed of the rotary motor from the second target angular speed to the third target angular speed in response to expiration of the second timer and receipt of a second measured temperature of the contents of the vessel 100 less than a second target temperature corresponding to a finishing temperature, the finishing temperature less than the phase-change temperature and corresponding to the second target viscosity. In particular, in this implementation, the apparatus 200 can transition between one preparation stage and the next preparation stage in response to receiving a reading from the temperature sensor that indicates contents of the vessel 100 have dropped below a target temperature corresponding to a target viscosity.

In another implementation, in Block S120, the apparatus: reduces the angular speed of the rotary motor from the first target angular speed to the second target angular speed in response to expiration of the first timer and electrical current supplied exceeding a first threshold electrical current corresponding to the first target viscosity; and, in Block S130, reduces the angular speed of the rotary motor from the second target angular speed to the third target angular speed in response to expiration of the second timer and electrical current exceeding a second threshold electrical current corresponding to the second target viscosity, the second threshold electrical current greater than the first threshold electrical current. In particular, in this implementation, the apparatus 200 can transition between one preparation stage and the next preparation stage in response to detecting an electrical current draw by the rotary motor exceeding a target threshold electrical current draw corresponding to a target viscosity.

When the apparatus 200 transitions into the maintenance stage, the contents of the vessel 100 represent a completed volume of frozen yogurt ready for consumption. The apparatus 200 can thus indicate to a user that the processing cycle is complete, such as by: flashing a lamp (e.g., a light-emitting diode, or “LED”) or changing the color of a lamp integrated into the apparatus 200, such as behind the “Start” button; and/or by issuing an audible prompt, such as through a speaker or buzzer integrated into the apparatus 200. However, because the user may not be immediately ready to consume the volume of frozen yogurt or immediately available to remove the vessel 100 from the receiver, the apparatus 200 can further reduce the speed of the rotary motor to a fourth target angular speed in Block S140 and reduce the power output of the refrigeration unit in Block S104 in order to maintain the state of the frozen yogurt in the vessel 100 without substantially changing the temperature, consistency, viscosity, mouth feel, etc. of the frozen yogurt. For example, the apparatus 200 can reduce the angular speed of the rotary motor to 10 rpm and reduce the power output of the refrigeration unit by 50%. In one example, in response to expiration of the third timer, the apparatus 200 can reduce a power level of the cooling element to a second power level to maintain the texture of the frozen mixture in Block S104. The apparatus 200 can maintain the rotary motor and the refrigeration unit in this state until the door of the apparatus is opened, the lid is pivoted from the closed position into the open position, the “Start” button is selected, the driveshaft is manually retracted, or any other suitable trigger to stop the processing cycle is detected by the apparatus 200. The apparatus 200 can then deactivate the rotary motor and the refrigeration unit and (if applicable) retract the driveshaft to enable the user to remove the vessel 100 from the receiver.

In one implementation, in Block S110, the apparatus can transition the rotary motor to the first target angular speed to rotate the rotary motor at the first target angular speed in order to mix the contents of the vessel 100 into a slurry; in Block S120, reduce the angular speed of the rotary motor to the second target angular speed to rotate the rotary motor at the second target angular speed less than the first target angular speed in order to solidify the slurry into a frozen mixture; in Block S130, reduce the angular speed of the rotary motor to the third target angular speed to rotate the rotary motor at the third target angular speed less than the second target angular speed in order to soften a texture of the frozen mixture; and, in Block S140, reduce the angular speed of the rotary motor to the fourth target angular speed less than the third target angular speed in order to maintain the texture of the frozen mixture.

In one variation of the method, in response to selection of a start button, the apparatus 200 can latch the rotary motor over the vessel 100 in Block 160; unlatch the rotary motor over the vessel 100 in response to expiration of the third timer; and stop the rotary motor in response to manual separation of the rotary motor from the receiver. For example, the apparatus 200 can unlatch and stop the rotary motor when the third timer has expired, indicating the end of the processing cycle. Additionally or alternatively, the apparatus 200 can stop the rotary motor in response to a user physically attempting to stop the processing cycle. For example, if the user attempts to remove the rotary motor from the vessel 100, the apparatus 200 can stop the rotary motor.

In one implementation, in addition to setting a minimum time duration for the preparation stages, the apparatus 200 can set maximum time duration for the preparation stages. In this implementation, setting the first timer of the first duration further includes setting a fourth timer of a fourth duration greater than the first duration; reducing the angular speed of the rotary motor from the first target angular speed to the second target angular speed further includes reducing the angular speed of the rotary motor from the first target angular speed to the second target angular speed in response to the earlier of: expiration of the first timer and detection of contents of the vessel 100 approximating the first target viscosity, and expiration of the fourth timer; setting the second timer of the second duration further includes setting a fifth timer of a fifth duration greater than the second duration; and reducing the angular speed of the rotary motor from the second target angular speed to the third target angular speed further includes reducing the angular speed of the rotary motor from the second target angular speed to the third target angular speed in response to the earlier of: expiration of the second timer and detection of contents of the vessel 100 approximating the second target viscosity, and expiration of the fifth timer.

In one example of the foregoing implementation, when transitioning from the cool and mix stage to the freeze stage, the apparatus 200 can set a second timer for a second duration of 120 seconds and fifth timer for a fifth duration of 180 seconds. In this example, the apparatus 200 can transition from the freeze stage to the finish stage when the second timer expires and the contents of the vessel 100 achieve the second target viscosity or when the fifth timer expires, whichever occurs first. The fifth duration functions as a maximum time duration for the finishing phase. The maximum time duration prevents the apparatus 200 from endlessly continuing the finishing phase in the event that the second target viscosity is never achieved.

The method S100 is described heretofore as executed by an apparatus 200 to achieve a cool and mix stage, a freeze (or “churn”) stage, a finish stage, and a maintenance stage. However, the method S100 can define any other number or type of preparation stages configured to achieve a desired viscosity, temperature, texture, and/or mouth feel of a frozen yogurt product created according to the method S100. Each preparation stage defines a particular combination of power level of the refrigeration unit, angular speed of the rotary motor, and triggers for transitioning to the next preparation stage.

For example, the method S100 can include a smooth stage between the finish stage and the maintenance stage. In this example, the smooth stage can define a reduced power output (e.g., 50%) of the refrigeration unit but an increased speed of the rotary motor in order to break any large ice crystal remaining in the vessel, thereby smoothing the finished frozen yogurt product and yielding a more presentable visual appearance. In particular, in this example, the smooth stage can define a target angular speed of speed of 90 rpm, which is greater than a target angular speed of 30 rpm defined by the finish stage. The smooth stage can also define a relatively short maximum duration timer (e.g., 30 seconds), a shorter minimum duration timer (e.g., 15 seconds), and a target viscosity to transition into the maintenance stage. Alternatively, the smooth stage can define a single-order time, such as 30 seconds. Yet alternatively, the smooth stage can define full power output (e.g., 100%) of the refrigeration unit and a new target speed of the rotary motor between the target angular speed defined in the freeze stage and the target angular speed defined in the maintenance stage in order to achieve a smoother, more presentable visual appearance before the vessel is released from the apparatus 200 for consumption.

### 6.1 Post-Finish Processing Cycle

In one variation of the method, after the processing cycle has concluded and the user has removed the vessel 100 from the receiver, the apparatus can forgo deactivating the refrigeration unit until receiving an input from the user requesting to end the processing cycle or until a threshold period of time (e.g., two minutes) following completion of the processing cycle. In response to the user placing the vessel back into the receiver before receiving an input from the user requesting to end the processing cycle or before the expiration of the threshold period of time, the apparatus can initiate a post-finish processing cycle. By forgoing deactivation of the refrigeration unit, the apparatus 200 is immediately prepared to further cool contents of the vessel during a post-finish processing cycle.

In this variation, the post-finish processing cycle can include an additional set of preparation stages. For example, the post-finish processing cycle can include an additional finish stage, as described above. The user may opt for a post-finish processing cycle including an additional finish stage when the user desires a softer finish for the finished frozen yogurt product. In another example, the post-finish processing cycle can include an additional freeze stage, as described above, and an additional finish stage. The user may opt for a post-finish processing cycle that includes an additional freeze stage and an additional finish stage when the user desires a thicker texture for the finished frozen yogurt product. Upon completion of the post-finish processing cycle (e.g., upon the expiration of an additional timer set for a preparation stage of the post-finish processing cycle), the apparatus 200 can indicate to the user that the post-finish processing cycle is complete and transition into an additional maintenance stage, as described above. Similarly, the apparatus 200 can maintain the refrigeration unit in this state defined by the maintenance stage until the door of the apparatus is opened, the lid is pivoted from the closed position into the open position, the “Start” button is selected, the driveshaft is manually retracted, or any other suitable trigger to stop the processing cycle is detected by the apparatus 200. The apparatus 200 can then deactivate the rotary motor and the refrigeration unit and (if applicable) retract the driveshaft or release the latch to enable the user to remove the vessel 100 from the receiver.

### 6.2 Custom Processing Cycles

In one variation, before or after selection of the “Start” button by the user, the apparatus 200 can allow the user to select a preset processing cycle option from a set of preset processing cycle options. Each preset processing cycle option of the set of preset processing cycle options includes a combination of preparation stages (e.g., a cool and mix stage, a freeze stage, and a finish stage); each preparation stage including a combination of power level of the refrigeration unit, rotation speed of the beater, and timer duration. For example, the set of preset processing cycle options can include a Standard Preparation, a Quick Preparation, and a Luxury Preparation. In one implementation, the Standard Preparation option includes a freeze stage in which the target speed of the rotary motor is ˜70 rpm and the minimum duration of the stage is 120 seconds. In this example, the Quick Preparation option includes a freeze stage in which the target speed of the rotary motor is ˜70 rpm, the minimum duration of the phase is 60 seconds, and the maximum duration of the phase is 100 seconds. In this example, the Luxury Preparation option includes a freeze stage in which the target speed of the rotary motor is ˜60 rpm and the minimum duration of the stage is 180 seconds. In another implementation, the Quick Preparation option and Luxury Preparation option can include preparation stages with timer durations that are scaled multiples of the timer durations included in the Standard Preparation option. For example, the Quick Preparation can include a freeze stage in which the target speed is the same as the target speed in the freeze stage of the Standard Preparation option and the minimum duration of the stage is 50% of the minimum duration of the freeze stage of the Standard Preparation option. While the Quick Preparation option may compromise the quality of the frozen food product by being shorter than the Standard Preparation option, a user may select the Quick Preparation option when time is a limiting factor for the user. Likewise, the user may select the Luxury Preparation option, which may ensure optimal quality of the frozen food product but require more time than the Standard Preparation option, when time is not a limiting factor for the user.

In a similar variation, before or after the selection of the “Start” button by the user, the apparatus 200 can allow the user to select a preparation time from a range of preparation times. For example, the apparatus 200 can allow the user to choose any whole number of minutes between three and ten minutes, inclusive. After receiving selection of a preparation time, the apparatus can optimize the processing cycle according to the preparation time selected by the user. In one implementation, the apparatus 200 can scale the timer durations included in the processing cycle according to the preparation time selected by the user. For example, if a general processing cycle requires a minimum of six minutes to complete, and includes a freeze stage with a minimum duration of 120 seconds (constituting one third of the total processing cycle), the apparatus 200 can scale the minimum duration of the freeze stage down to 60 seconds following a selection of a preparation time of three minutes, such that the freeze stage continues to constitute one third of the total processing cycle. In another implementation, following a selection of a preparation time, the apparatus 200 can modify the parameters of the processing cycle according to an algorithm and the selected preparation time.

In a similar variation, before or after the selection of the “Start” button by the user, the apparatus can allow the user to input an indication of the type of frozen yogurt product contained within the vessel 100. For example, the apparatus 200 can allow the user to input a chocolate indicator, indicating that the vessel 100 placed into the receiver contains contents necessary to create a chocolate frozen yogurt product. The apparatus 200 can then modify the processing cycle according to the type of frozen yogurt product contained within the vessel 100. As described above, different types of frozen yogurt products may require different processing cycles to achieve an optimal finish.

However, the apparatus 200 can implement any other methods and techniques to transform the frozen yogurt base and added liquid into frozen yogurt (or any other frozen food product).

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for preparing a frozen food product comprising:
following insertion of a vessel containing a liquid food product into a receiver:
activating a cooling element thermally coupled to the receiver at a first power level;
transitioning a rotary motor from rest to a first target angular speed, the rotary motor mechanically coupled to a beater integrated into the vessel; and
setting a first timer of a first duration;
in response to expiration of the first timer and detection of contents of the vessel approximating a first target viscosity:
reducing an angular speed of the rotary motor from the first target angular speed to a second target angular speed; and
setting a second timer of a second duration;
in response to expiration of the second timer and detection of the contents of the vessel approximating a second target viscosity greater than the first target viscosity:
reducing the angular speed of the rotary motor from the second target angular speed to a third target angular speed; and
setting a third timer of a third duration; and
in response to expiration of the third timer:
reducing the angular speed of the rotary motor from the third target angular speed to a fourth target angular speed; and
indicating completion of a frozen food product in the vessel.

2. The method of claim 1, further comprising:
in response to selection of a start button, latching the rotary motor over the vessel;
unlatching the rotary motor over the vessel in response to expiration of the third timer; and
stopping the rotary motor in response to manual separation of the rotary motor from the receiver.

3. The method of claim 1:
wherein reducing the angular speed of the rotary motor from the first target angular speed to the second target angular speed comprises reducing the angular speed of the rotary motor from the first target angular speed to the second target angular speed in response to expiration of the first timer and receipt of the first measured temperature of contents of the vessel less than a first target temperature approximating a phase-change temperature of contents of the vessel and corresponding to the first target viscosity; and
wherein reducing the angular speed of the rotary motor from the second target angular speed to the third target angular speed comprises reducing the angular speed of the rotary motor from the second target angular speed to the third target angular speed in response to expiration of the second timer and receipt of the second measured temperature of contents of the vessel less than a second target temperature corresponding to a finishing temperature, the finishing temperature less than the phase-change temperature and corresponding to the second target viscosity.

4. The method of claim 1:
wherein reducing the angular speed of the rotary motor from the first target angular speed to the second target angular speed comprises reducing the angular speed of the rotary motor from the first target angular speed to the second target angular speed in response to expiration of the first timer and electrical current supplied exceeding a first threshold electrical current corresponding to the first target viscosity; and
wherein reducing the angular speed of the rotary motor from the second target angular speed to the third target angular speed comprises reducing the angular speed of the rotary motor from the second target angular speed to the third target angular speed in response to expiration of the second timer and electrical current supplied to the rotary motor to maintain the second target angular speed exceeding a second threshold electrical current corresponding to the second viscosity, the second threshold electrical current greater than the first threshold electrical current.

5. The method of claim 1:
wherein transitioning the rotary motor to the first target angular speed comprises rotating the rotary motor at the first target angular speed to mix the contents of the vessel into a slurry;
wherein reducing the angular speed of the rotary motor to the second target angular speed comprises rotating the rotary motor at the second target angular speed less than the first target angular speed to solidify the slurry into a frozen mixture;
wherein reducing the angular speed of the rotary motor to the third target angular speed comprises rotating the rotary motor at the third target angular speed less than the second target angular speed to soften a texture of the frozen mixture; and
wherein reducing the angular speed of the rotary motor to the fourth target angular speed comprises rotating the rotary motor at the fourth target angular speed less than the third target angular speed to maintain the texture of the frozen mixture.

6. The method of claim 5, further comprising, in response to expiration of the third timer, reducing a power level of the cooling element to a second power level to maintain the texture of the frozen mixture.

7. The method of claim 1:
wherein setting the first timer of the first duration further comprises setting a fourth timer of a fourth duration greater than the first duration;
wherein reducing the angular speed of the rotary motor from the first target angular speed to the second target angular speed comprises reducing the angular speed of the rotary motor from the first target angular speed to the second target angular speed in response to the earlier of:
expiration of the first timer and detection of contents of the vessel approximating the first target viscosity; and
expiration of the fourth timer;
wherein setting the second timer of the second duration further comprises setting a fifth timer of a fifth duration greater than the second duration; and
wherein reducing the angular speed of the rotary motor from the first target angular speed to the second target angular speed comprises reducing the angular speed of the rotary motor from the first target angular speed to the second target angular speed in response to the earlier of:
expiration of the second timer and detection of contents of the vessel approximating the second target viscosity; and
expiration of the fifth timer.

8. A method for preparing a frozen food product comprising:
following insertion of a vessel containing the liquid food product into a receiver:
activating a cooling element thermally coupled to the receiver at a first power level;
transitioning a rotary motor from rest to a first target angular speed, the rotary motor mechanically coupled to a beater integrated into the vessel; and
setting a first timer of a first duration;
at the earlier of expiration of the first timer and detection of contents of the vessel approximating a first target viscosity:
transitioning the rotary motor from the first target angular speed to a second target angular speed; and
in response to detection of the contents of the vessel approximating a second target viscosity greater than the first target viscosity:
transitioning the rotary motor from the second target angular speed to a third target angular speed.

9. The method of claim 8, further comprising:
at the earlier of expiration of the first timer and detection of contents of the vessel approximating a first target viscosity:
setting a second timer of a second duration;
at the earlier of expiration of the second timer and detection of the contents of the vessel approximating a second target viscosity greater than the first target viscosity:
setting a third timer of a third duration; and,
in response to expiration of the third timer:
indicating completion of a frozen food product in the vessel 100;
reducing the angular speed of the rotary motor from the third target angular speed to a fourth target angular speed to maintain a texture of the contents of the vessel; and
reducing a power level of the cooling element to a second power level.

10. The method of claim 8:
wherein transitioning an angular speed of the rotary motor from a stop to a first target angular speed comprises rotating the rotary motor at the first target angular speed to mix the contents of the vessel into a slurry;
wherein transitioning the angular speed of the rotary motor from the first target angular speed to a second target angular speed comprises reducing the angular speed of the rotary motor from the first target angular speed to the second target angular speed to solidify the slurry into a frozen mixture; and
wherein transitioning the angular speed of the rotary motor from the second target angular speed to a third target angular speed comprises reducing the angular speed of the rotary motor from the second target angular speed to the third target angular speed to soften a texture of the frozen mixture.

11. An apparatus for preparing a frozen food product comprising:
a base;
a receiver arranged in the base and configured to transiently receive a vessel, the receiver comprising a thermally-conductive material and defining an internal section defining a draft angle approximating a draft angle of the vessel;
a cooling element arranged in the base and thermally coupled to the receiver;
a lid arranged over the receiver, coupled to the base, and operable in an open position and a closed position;
a rotary motor arranged within the lid;
a driveshaft coupled to the rotary motor and, with the lid in the closed position, configured to:
transiently engage a beater arranged in the vessel; and
depress the vessel into the receiver; and
a window extending from the lid and configured to enclose the vessel and the driveshaft between the base and the lid when the lid is in the closed position.

12. The apparatus of claim 11, further comprising a controller configured to:
following insertion of a vessel containing the liquid food product into a receiver:
activate the cooling element at a first power level;
transition the rotary motor from rest to a first target angular speed; and
set a first timer of a first duration;
in response to expiration of the first timer and detection of the contents of the vessel approximating a first target viscosity:
reduce an angular speed of the rotary motor from the first target angular speed to a second target angular speed; and
set a second timer of a second duration;
in response to expiration of the second timer and detection of the contents of the vessel approximating a second target viscosity greater than the first target viscosity:
reduce the angular speed of the rotary motor from the second target angular speed to a third target angular speed; and
set a third timer of a third duration; and
in response to expiration of the third timer:
reduce the angular speed of the rotary motor from the third target angular speed to a fourth target angular speed; and
indicate completion of a frozen food product in the vessel.

13. The apparatus of claim 12, wherein the controller is further configured to:
monitor current draw of the rotary motor; and
transform current draw of the rotary motor into viscosity of contents of the vessel.

14. The apparatus of claim 12:
further comprising:
a spring coupling interposed between the driveshaft and the rotary motor, configured to absorb distance variations between the rotary motor and the beater, and configured to thrust the driveshaft toward the beater;
a contact sensor coupled to the spring coupling and configured to output a signal corresponding to depression of the driveshaft toward the rotary motor; and
wherein the controller is configured to:
confirm correct engagement between the driveshaft and the beater based on an output of the contact sensor; and
transition the rotary motor from to the first target angular speed in response to confirmation of correct engagement between the driveshaft and the beater.

15. The apparatus of claim 11, wherein the window comprises a set of tabs configured to contact a flange on the top perimeter of the vessel and to depress the vessel into the receiver with the lid in the closed position.

16. The apparatus of claim 11, wherein the driveshaft defines a tapered internal spline configured to mate with and to align to a tapered external spline extending from the beater.

17. The apparatus of claim 11, further comprising the vessel, the vessel comprising:
an outer wall comprising a first frustoconical section defining a central axis and declined toward the central axis;
a rim extending laterally from an upper edge of the outer wall and away from the central axis;
a base extending from a lower edge of the outer wall toward the central axis;
a beater comprising:
a drive coupling arranged over the shelf and configured to rotate about the central axis;
a first blade extending from the drive coupling, along the base, and up a portion of the outer wall; and
a second blade radially offset from the first blade and extending from the drive coupling, along the base, and up a portion of the outer wall;
a seal extending across the upper edge of the outer wall and transiently enclosing a volume defined by the outer wall, the base, and the stanchion; and
a powdered food product contained with the volume.

18. The apparatus of claim 17, wherein the stanchion further defines a horizontal shelf below the upper edge of the outer wall and defines a liquid fill level.

19. The apparatus of claim 11, wherein the cooling element comprises:
a fluid manifold proximal the receiver;
a thermoelectric cooler comprising a cold junction thermally coupled to the receiver and a hot junction thermally coupled to the fluid manifold;
a radiator fluidly coupled to the fluid manifold; and
a pump configured to pump fluid between the fluid manifold and the radiator.

20. The apparatus of claim 11:
further comprising a latch configured to retain the lid in the closed position;
wherein the lid is pivotably coupled to a rear of the base;
wherein the window comprises a transparent material and is configured to enclose the vessel and the driveshaft between the base and the lid with the lid in the closed position; and
wherein the latch is configured to draw the lid downward toward the base to depress the vessel into the receiver.
